(19) United States
(12) Patent Application Publication
(10) Pub. No.: US 2024/0406917 A1
(43) Pub. Date: Dec. 5, 2024

(54) SCHEDULING OF PAGING OCCASION BASED UPON TIMING OF POSITIONING REFERENCE SIGNAL INSTANCE

(71) Applicant: QUALCOMM Incorporated, San Diego, CA (US)

(72) Inventors: Alexandros MANOLAKOS, Athens (GR); Jing LEI, San Diego, CA (US); Weimin DUAN, San Diego, CA (US); Hung Dinh LY, San Diego, CA (US); Yuchul KIM, San Diego, CA (US); Peter GAAL, San Diego, CA (US)

(21) Appl. No.: 18/699,501

(22) PCT Filed: Sep. 26, 2022
(86) PCT No.: PCT/US2022/076996

§ 371 Date: Apr. 8, 2024

(30) Foreign Application Priority Data
Oct. 20, 2021 (GR) 20210100716

(51) Int. Cl. H04W 64/00; H04W 68/02; H04W 76/28

(52) U.S. Cl. CPC H04W 64/00; H04W 68/02; H04W 76/28

(57) ABSTRACT

Disclosed are techniques for wireless communication. In an aspect, timing of a PRS instance is determined, and timing of a PO is determined based at least in part upon the timing of the PRS instance. UE transitions from DRX OFF state to DRX ON state and receives/measures the PO and PRS resource(s) of the PRS instance (e.g., without returning to DRX OFF state or sleep state until both the PO and PRS resource(s) are received/measured).

### CROSS-REFERENCE TO RELATED APPLICATIONS

The present application for patent claims the benefit of GR Application No. 2021010716, entitled “SCHEDULING OF PAGING OCCASION BASED UPON TIMING OF POSITIONING REFERENCE SIGNAL INSTANCE”, filed Oct. 20, 2021, and is a national stage application, filed under 35 U.S.C. § 371, of International Patent Application No. PCT/US2022/076996, entitled, “SCHEDULING OF PAGING OCCASION BASED UPON TIMING OF POSITIONING REFERENCE SIGNAL INSTANCE”, filed Sep. 26, 2022, both of which are assigned to the assignee hereof and are expressly incorporated herein by reference in their entirety.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein, Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of operating a user equipment (UE) includes determining a first window of time associated with a periodic positioning reference signal (PRS) instance; determining a second window of time associated with a paging occasion (PO) of the UE based in part upon the first window of time associated with the PRS instance; transitioning from a discontinuous reception (DRX) OFF state to a DRX ON state; monitoring, while in the DRX ON state, the PO during the second window of time; performing, while in the DRX ON state, one or more measurements of one or more PRS resources associated with the PRS instance during the first window of time; and transitioning from the DRX ON state to the DRX OFF state after the first window of time and the second window of time.

In an aspect, a method of operating a base station includes determining a first window of time associated with a periodic positioning reference signal (PRS) instance for a user equipment (UE); determining a second window of time associated with a paging occasion (PO) of the UE based in part upon the first window of time associated with the PRS instance; transmitting paging information associated with the PO during the second window of time; and transmitting PRS on one or more PRS resources associated with the PRS instance during the first window of time.

In an aspect, a user equipment (UE) includes a memory; at least one transceiver; and at least one processor communicatively coupled to the memory and the at least one transceiver, the at least one processor configured to: determine a first window of time associated with a periodic positioning reference signal (PRS) instance; determine a second window of time associated with a paging occasion (PO) of the UE based in part upon the first window of time associated with the PRS instance: transition from a discontinuous reception (DRX) OFF state to a DRX ON state; monitor, while in the DRX ON state, the PO during the second window of time; perform, while in the DRX ON state, one or more measurements of one or more PRS resources associated with the PRS instance during the first window of time; and transition from the DRX ON state to the DRX OFF state after the first window of time and the second window of time.

In an aspect, a base station includes a memory; at least one transceiver; and at least one processor communicatively coupled to the memory and the at least one transceiver, the at least one processor configured to: determine a first window of time associated with a periodic positioning reference signal (PRS) instance for a user equipment (UE); determine a second window of time associated with a paging occasion (PO) of the UE based in part upon the first window of time associated with the PRS instance; transmit, via the at least one transceiver, paging information associated with the PO during the second window of time; and transmit, via the at least one transceiver, PRS on one or more PRS resources associated with the PRS instance during the first window of time.

In an aspect, a user equipment (UE) includes means for determining a first window of time associated with a periodic positioning reference signal (PRS) instance; means for determining a second window of time associated with a paging occasion (PO) of the UE based in pail upon the first window of time associated with the PRS instance; means for transitioning from a discontinuous reception (DRX) OFF state to a DRX ON state; means for monitoring, while in the DRY ON state, the PO during the second window of time; means for performing, while in the DRX ON state, one or more measurements of one or more PRS resources associated with the PRS instance during the first window of time; and means for transitioning from the DRX ON state to the DRX OFF state after the first window of time and the second window of time.

In an aspect, a base station includes means for determining a first window of time associated with a periodic positioning reference signal (PRS) instance for a user equipment (UE); means for determining a second window of time associated with a paging occasion (PO) of the UE based in part upon the first window of time associated with the PRS instance; means for transmitting paging information associated with the PO during the second window of time; and means for transmitting PRS on one or more PRS resources associated with the PRS instance during the first window of time.

In an aspect, a non-transitory computer-readable medium storing computer-executable instructions that, when executed by a user equipment (UE), cause the UE to: determine a first window of time associated with a periodic positioning reference signal (PRS) instance; determine a second window of time associated with a paging occasion (PO) of the UE based in part upon the first window of time associated with the PRS instance; transition from a discontinuous reception (DRX) OFF state to a DRX ON state; monitor, while in the DRX ON state, the PO during the second window of time; perform, while in the DRX ON state, one or more measurements of one or more PRS resources associated with the PRS instance during the first window of time; and transition from the DRX ON state to the DRX OFF state after the first window of time and the second window of time.

In an aspect, a non-transitory computer-readable medium storing computer-executable instructions that, when executed by a base station, cause the base station to: determine a first window of time associated with a periodic positioning reference signal (PRS) instance for a user equipment (UE); determine a second window of time associated with a paging occasion (PO) of the UE based in part upon the first window of time associated with the PRS instance; transmit paging information associated with the PO during the second window of time; and transmit PRS on one or more PRS resources associated with the PRS instance during the first window of time.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 is a diagram illustrating an example frame structure, according to aspects of the disclosure.

FIG. 5 is a diagram illustrating various downlink channels within an example downlink slot, according to aspects of the disclosure.

FIG. 6 is a diagram of an example positioning reference signal (PRS) configuration for the PRS transmissions of a given base station, according to aspects of the disclosure.

FIG. 7 is a diagram illustrating an example downlink positioning reference signal (DL-PRS) configuration for two transmission-reception points (TRPs) operating in the same positioning frequency layer, according to aspects of the disclosure.

FIG. 8 illustrates examples of various positioning methods supported in New Radio (NR), according to aspects of the disclosure.

FIGS. 9A to 9C illustrate example discontinuous reception (DRX) configurations, according to aspects of the disclosure.

FIG. 10 illustrates an example four-step random access procedures, according to aspects of the disclosure.

FIG. 11 illustrates an example two-step random access procedure, according to aspects of the disclosure.

FIG. 12 illustrates an RRC Idle/Inactive PRS processing scheme, in accordance with aspects of the disclosure.

FIG. 13 illustrates an RRC Connected PRS processing scheme for PRS inside DRX ON duration, in accordance with aspects of the disclosure.

FIG. 14 illustrates an RRC Connected PRS processing scheme for PRS outside DRX ON duration, in accordance with aspects of the disclosure.

FIG. 15 illustrates an exemplary process of wireless communication, according to aspects of the disclosure.

FIG. 16 illustrates an exemplary process of wireless communication, according to aspects of the disclosure.

FIG. 17 illustrates an example implementation of FIGS. 15-16, in accordance with aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example. “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station.” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

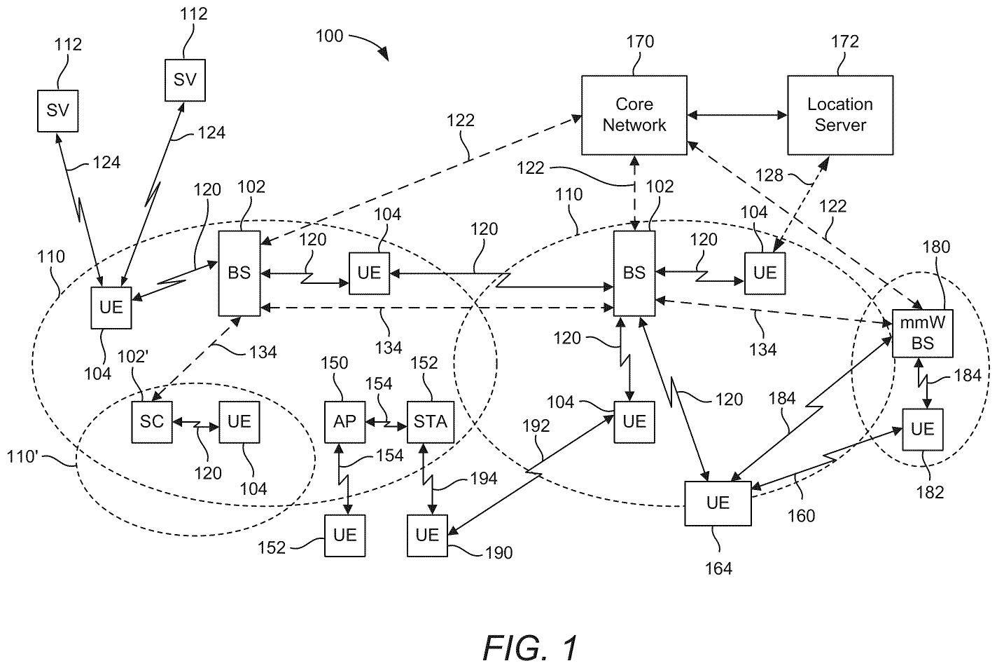

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mm W frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell.” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell.” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102″, access point 150), etc. Thus, in some cases. UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on.

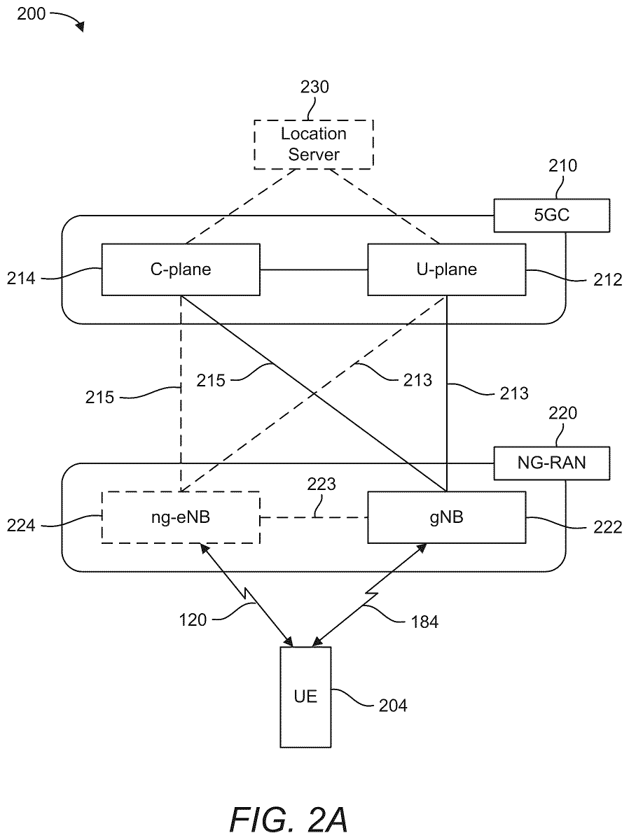

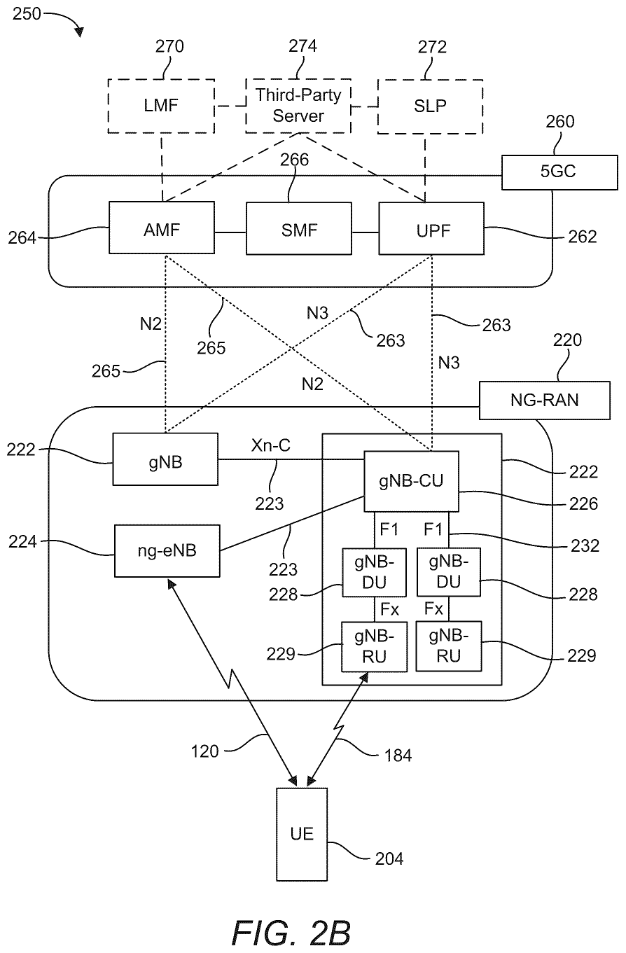

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 250. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

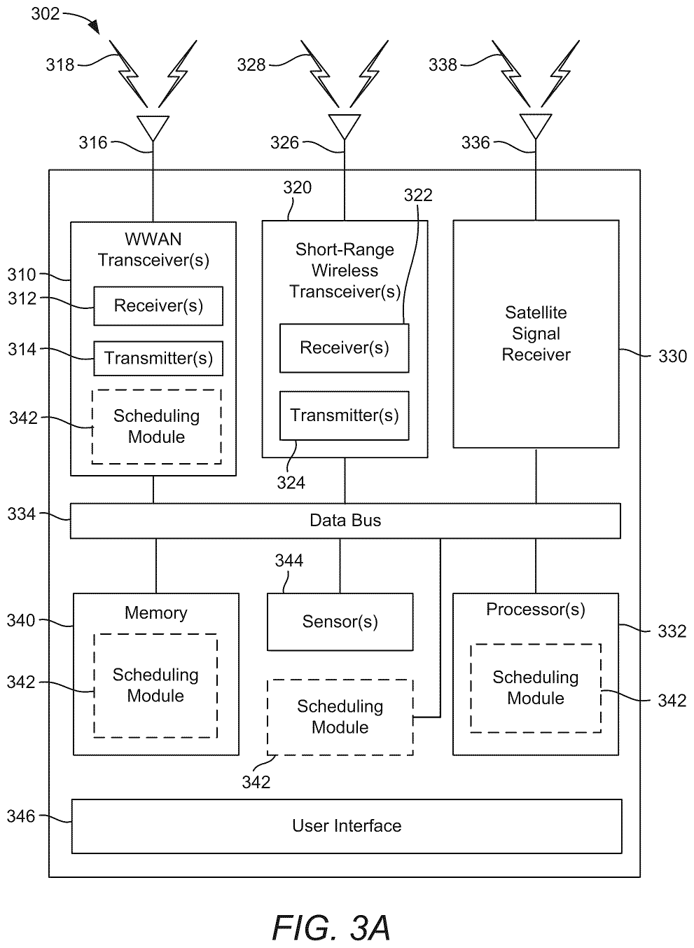

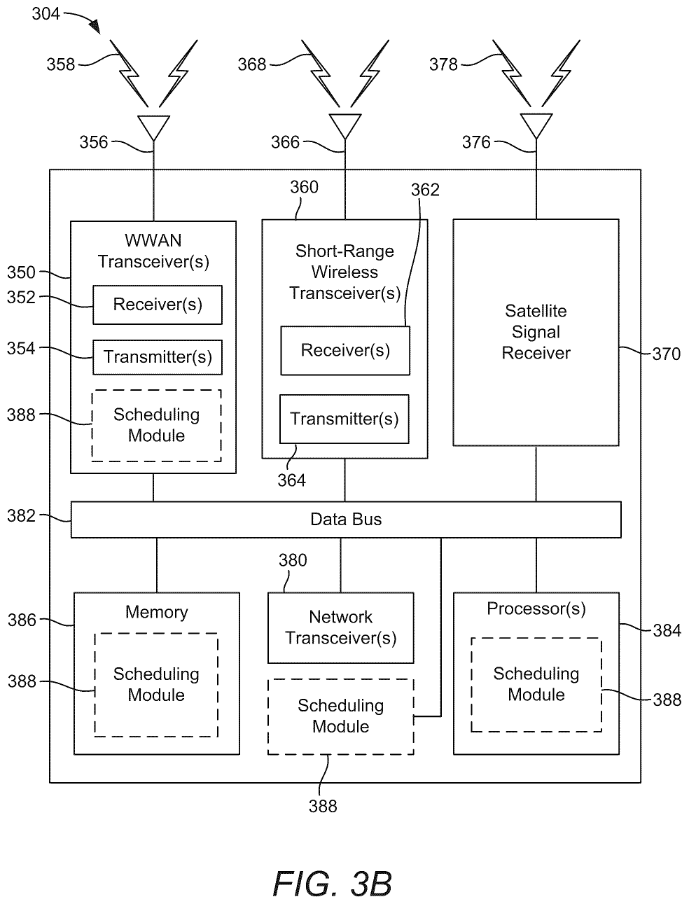

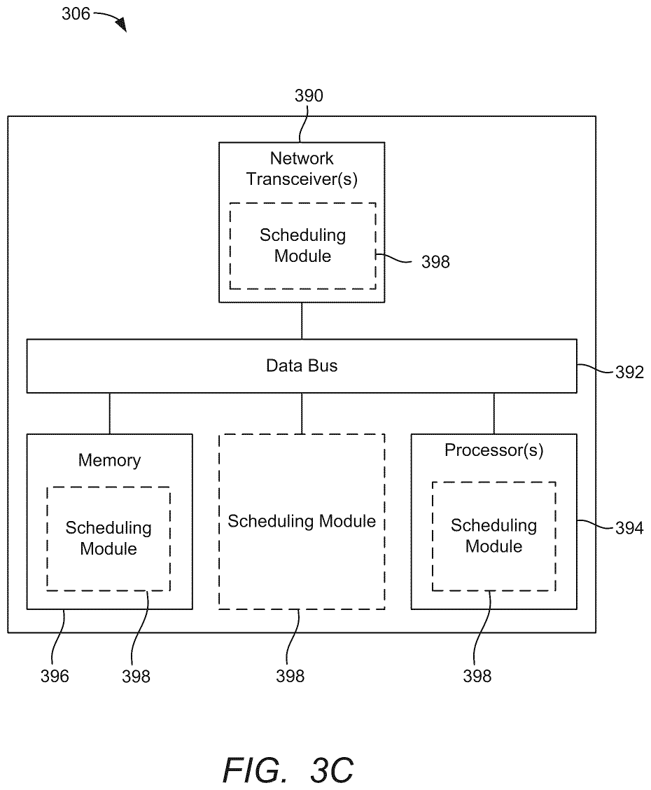

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the file transmission operations as taught herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC). Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming.” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs). ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include scheduling module 342, 388, and 398, respectively. The scheduling module 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the scheduling module 342, 388, and 398 may be external to the processors 332, 384, and 394 (e.g., part of a modem processing system, integrated with another processing system, etc.). Alternatively, the scheduling module 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the scheduling module 342, which may be, for example, part of the one or more WWAN transceivers 310, the memory 340, the one or more processors 332, or any combination thereof, or may be a standalone component. FIG. 3B illustrates possible locations of the scheduling module 388, which may be, for example, part of the one or more WWAN transceivers 350, the memory 386, the one or more processors 384, or any combination thereof, or may be a standalone component. FIG. 3C illustrates possible locations of the scheduling module 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) laver. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer: functionality associated with header compression/decompression, security (ciphering, deciphering, integrity protection, integrity verification), and handover support functions: RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the uplink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A. 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE.” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the scheduling module 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

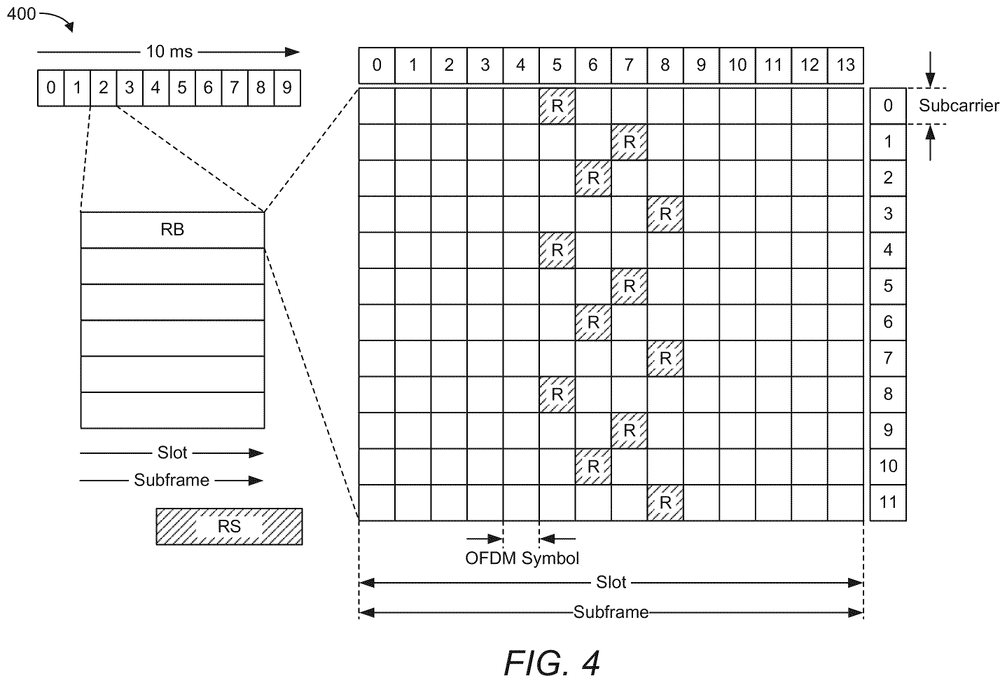

Various frame structures may be used to support downlink and uplink transmissions between network nodes (e.g., base stations and UEs). FIG. 4 is a diagram 400 illustrating an example frame structure, according to aspects of the disclosure. The frame structure may be a downlink or uplink frame structure. Other wireless communications technologies may have different frame structures and/or different channels.

LTE, and in some cases NR, utilizes OFDM on the downlink and single-carrier frequency division multiplexing (SC-FDM) on the uplink. Unlike LTE, however, NR has an option to use OFDM on the uplink as well. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may be dependent on the system bandwidth. For example, the spacing of the subcarriers may be 15 kilohertz (kHz) and the minimum resource allocation (resource block) may be 12 subcarriers (or 180 kHz). Consequently, the nominal FFT size may be equal to 128, 256, 512, 1024, or 2048 for system bandwidth of 1.25, 2.5, 5, 10, or 20 megahertz (MHz), respectively. The system bandwidth may also be partitioned into subbands. For example, a subband may cover 1.08 MHz (i.e., 6 resource blocks), and there may be 1, 2, 4, 8, or 16 subbands for system bandwidth of 1.25, 2.5, 5, 10, or 20 MHz, respectively.

LTE supports a single numerology (subcarrier spacing (SCS), symbol length, etc.). In contrast, NR may support multiple numerologies (u), for example, subcarrier spacings of 15 kHz (μ=0). 30 kHz (μ=1), 60 kHz (μ=2). 120 kHz (μ=3), and 240 kHz (μ=4) or greater may be available. In each subcarrier spacing, there are 14 symbols per slot. For 15 kHz SCS (ρ=0), there is one slot per subframe, 10 slots per frame, the slot duration is 1 millisecond (ms), the symbol duration is 66.7 microseconds (μs), and the maximum nominal system bandwidth (in MHz) with a 4K FFT size is 50. For 30 kHz SCS (μ=1), there are two slots per subframe, 20 slots per frame, the slot duration is 0.5 ms, the symbol duration is 33.3 μs, and the maximum nominal system bandwidth (in MHz) with a 4K FFT size is 100. For 60 kHz SCS (μ=2), there are four slots per subframe, 40 slots per frame, the slot duration is 0.25 ms, the symbol duration is 16.7 μs, and the maximum nominal system bandwidth (in MHz) with a 4K FFT size is 200. For 120 kHz SCS (μ=3), there are eight slots per subframe, 80 slots per frame, the slot duration is 0.125 ms, the symbol duration is 8.33 μs, and the maximum nominal system bandwidth (in MHz) with a 4K FFT size is 400. For 240 kHz SCS (μ=4), there are 16 slots per subframe, 160 slots per frame, the slot duration is 0.0625 ms, the symbol duration is 4.17 μs, and the maximum nominal system bandwidth (in MHz) with a 4K FFT size is 800.

In the example of FIG. 4, a numerology of 15 KHz is used. Thus, in the time domain, a 10 ms frame is divided into 10 equally sized subframes of 1 ms each, and each subframe includes one time slot. In FIG. 4, time is represented horizontally (on the X axis) with time increasing from left to right, while frequency is represented vertically (on the Y axis) with frequency increasing (or decreasing) from bottom to top.

A resource grid may be used to represent time slots, each time slot including one or more time-concurrent resource blocks (RBs) (also referred to as physical RBs (PRBs)) in the frequency domain. The resource grid is further divided into multiple resource elements (REs). An RE may correspond to one symbol length in the time domain and one subcarrier in the frequency domain. In the numerology of FIG. 4, for a normal cyclic prefix, an RB may contain 12 consecutive subcarriers in the frequency domain and seven consecutive symbols in the time domain, for a total of 84 REs. For an extended cyclic prefix, an RB may contain 12 consecutive subcarriers in the frequency domain and six consecutive symbols in the time domain, for a total of 72 REs. The number of bits carried by each RE depends on the modulation scheme.

Some of the REs may carry reference (pilot) signals (RS). The reference signals may include positioning reference signals (PRS), tracking reference signals (TRS), phase tracking reference signals (PTRS), cell-specific reference signals (CRS), channel state information reference signals (CSI-RS), demodulation reference signals (DMRS), primary synchronization signals (PSS), secondary synchronization signals (SSS), synchronization signal blocks (SSBs), sounding reference signals (SRS), etc., depending on whether the illustrated frame structure is used for uplink or downlink communication. FIG. 4 illustrates example locations of REs carrying a reference signal (labeled “R”).

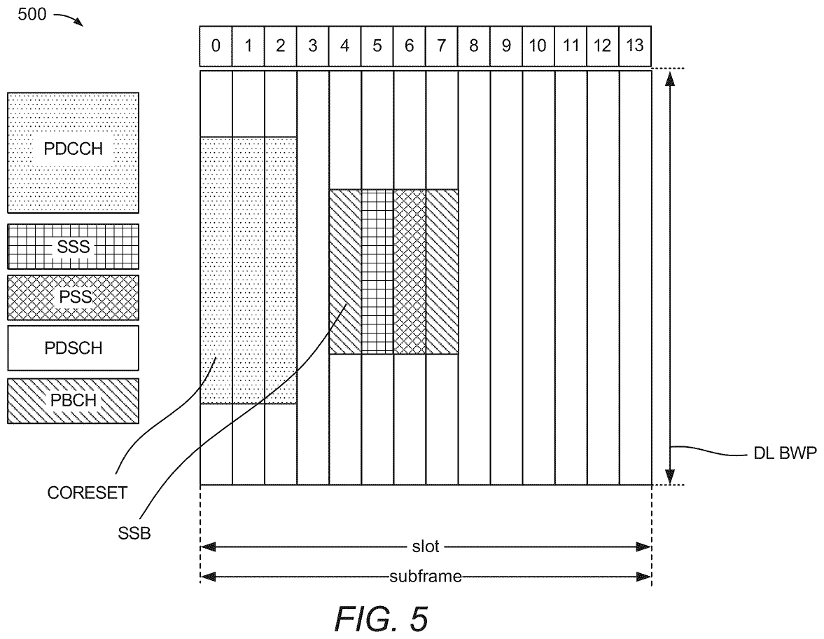

FIG. 5 is a diagram 500 illustrating various downlink channels within an example downlink slot. In FIG. 5, time is represented horizontally (on the X axis) with time increasing from left to right, while frequency is represented vertically (on the Y axis) with frequency increasing (or decreasing) from bottom to top. In the example of FIG. 5, a numerology of 15 kHz is used. Thus, in the time domain, the illustrated slot is one millisecond (ms) in length, divided into 14 symbols.

In NR, the channel bandwidth, or system bandwidth, is divided into multiple bandwidth parts (BWPs). A BWP is a contiguous set of RBs selected from a contiguous subset of the common RBs for a given numerology on a given carrier. Generally, a maximum of four BWPs can be specified in the downlink and uplink. That is, a UE can be configured with up to four BWPs on the downlink, and up to four BWPs on the uplink. Only one BWP (uplink or downlink) may be active at a given time, meaning the UE may only receive or transmit over one BWP at a time. On the downlink, the bandwidth of each BWP should be equal to or greater than the bandwidth of the SSB, but it may or may not contain the SSB.

Referring to FIG. 5, a primary synchronization signal (PSS) is used by a UE to determine subframe/symbol timing and a physical layer identity. A secondary synchronization signal (SSS) is used by a UE to determine a physical layer cell identity group number and radio frame timing. Based on the physical layer identity and the physical layer cell identity group number, the UE can determine a PCI. Based on the PCI, the UE can determine the locations of the aforementioned DL-RS. The physical broadcast channel (PBCH), which carries a master information block (MIB), may be logically grouped with the PSS and SSS to form an SSB (also referred to as an SS/PBCH). The MIB provides a number of RBs in the downlink system bandwidth and a system frame number (SFN). The physical downlink shared channel (PDSCH) carries user data, broadcast system information not transmitted through the PBCH, such as system information blocks (SIBs), and paging messages.

The physical downlink control channel (PDCCH) carries downlink control information (DCI) within one or more control channel elements (CCEs), each CCE including one or more RE group (REG) bundles (which may span multiple symbols in the time domain), each REG bundle including one or more REGs, each REG corresponding to 12 resource elements (one resource block) in the frequency domain and one OFDM symbol in the time domain. The set of physical resources used to carry the PDCCH/DCI is referred to in NR as the control resource set (CORESET). In NR, a PDCCH is confined to a single CORESET and is transmitted with its own DMRS. This enables UE-specific beamforming for the PDCCH.

In the example of FIG. 5, there is one CORESET per BWP, and the CORESET spans three symbols (although it may be only one or two symbols) in the time domain. Unlike LTE control channels, which occupy the entire system bandwidth, in NR, PDCCH channels are localized to a specific region in the frequency domain (i.e., a CORESET). Thus, the frequency component of the PDCCH shown in FIG. 5 is illustrated as less than a single BWP in the frequency domain. Note that although the illustrated CORESET is contiguous in the frequency domain, it need not be. In addition, the CORESET may span less than three symbols in the time domain.

The DCI within the PDCCH carries information about uplink resource allocation (persistent and non-persistent) and descriptions about downlink data transmitted to the UE, referred to as uplink and downlink grants, respectively. More specifically, the DCI indicates the resources scheduled for the downlink data channel (e.g., PDSCH) and the uplink data channel (e.g., physical uplink shared channel (PUSCH)). Multiple (e.g., up to eight) DCIs can be configured in the PDCCH, and these DCIs can have one of multiple formats. For example, there are different DCI formats for uplink scheduling, for downlink scheduling, for uplink transmit power control (TPC), etc. A PDCCH may be transported by 1, 2, 4, 8, or 16 CCEs in order to accommodate different DCI payload sizes or coding rates.

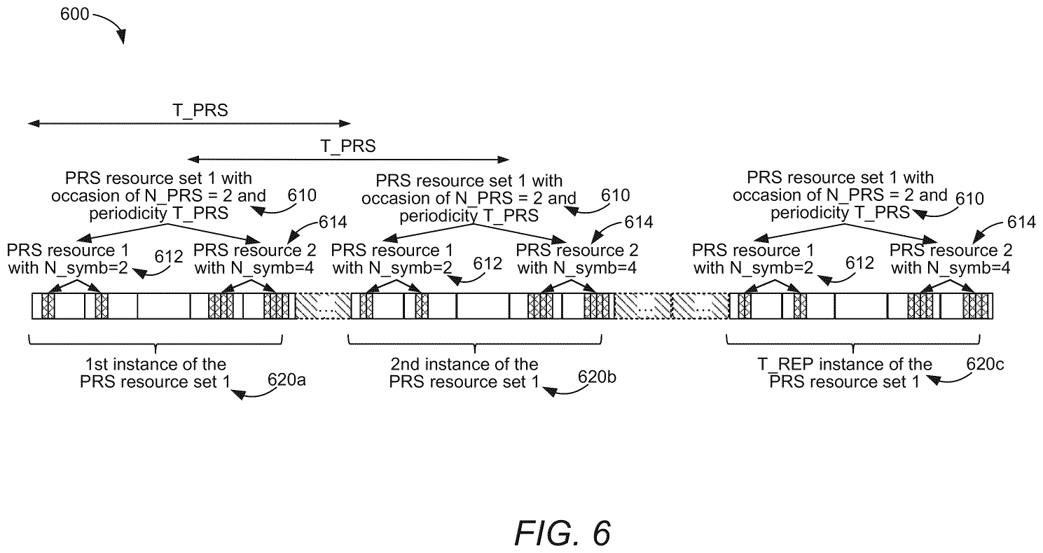

FIG. 6 is a diagram of an example PRS configuration 600 for the PRS transmissions of a given base station, according to aspects of the disclosure. In FIG. 6, time is represented horizontally, increasing from left to right. Each long rectangle represents a slot and each short (shaded) rectangle represents an OFDM symbol. In the example of FIG. 6, a PRS resource set 610 (labeled “PRS resource set 1”) includes two PRS resources, a first PRS resource 612 (labeled “PRS resource 1”) and a second PRS resource 614 (labeled “PRS resource 2”). The base station transmits PRS on the PRS resources 612 and 614 of the PRS resource set 610.

The PRS resource set 610 has an occasion length (N_PRS) of two slots and a periodicity (T_PRS) of, for example, 160 slots or 160 milliseconds (ms) (for 15 kHz subcarrier spacing). As such, both the PRS resources 612 and 614 are two consecutive slots in length and repeat every T_PRS slots, starting from the slot in which the first symbol of the respective PRS resource occurs. In the example of FIG. 6, the PRS resource 612 has a symbol length (N_symb) of two symbols, and the PRS resource 614 has a symbol length (N_symb) of four symbols. The PRS resource 612 and the PRS resource 614 may be transmitted on separate beams of the same base station.

Each instance of the PRS resource set 610, illustrated as instances 620a, 620b, and 620c, includes an occasion of length: ‘2’ (i.e., N_PRS=2) for each PRS resource 612, 614 of the PRS resource set. The PRS resources 612 and 614 are repeated every T_PRS slots up to the muting sequence periodicity T_REP. As such, a bitmap of length T_REP would be needed to indicate which occasions of instances 620a, 620b, and 620c of PRS resource set 610 are muted (i.e., not transmitted).

In an aspect, there may be additional constraints on the PRS configuration 600. For example, for all PRS resources (e.g., PRS resources 612, 614) of a PRS resource set (e.g., PRS resource set 610), the base station can configure the following parameters to be the same: (a) the occasion length (N_PRS), (b) the number of symbols (N_symb), (c) the comb type, and/or (d) the bandwidth. In addition, for all PRS resources of all PRS resource sets, the subcarrier spacing and the cyclic prefix can be configured to be the same for one base station or for all base stations. Whether it is for one base station or all base stations may depend on the UE's capability to support the first and/or second option.

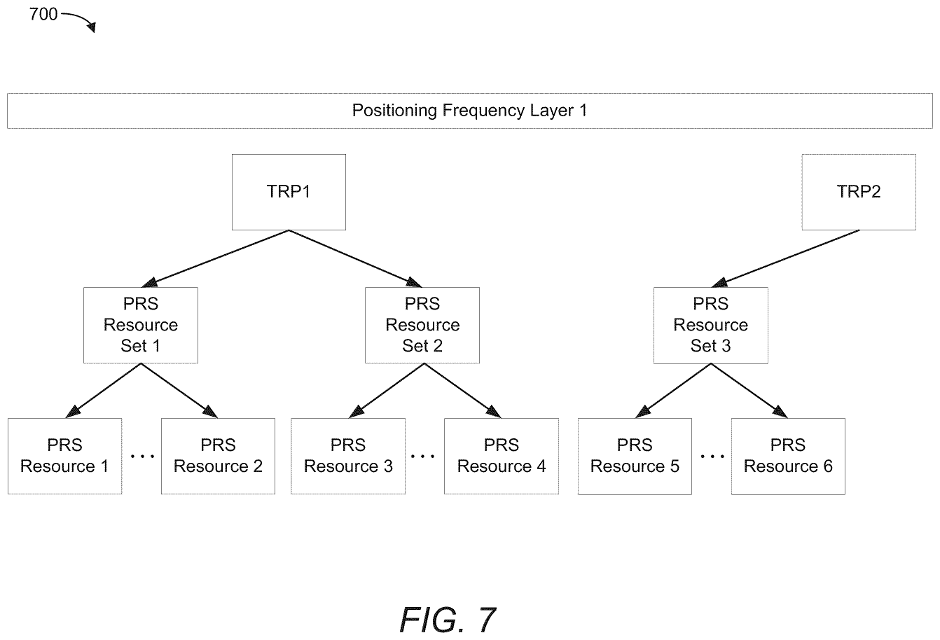

FIG. 7 is a diagram 700 illustrating an example PRS configuration for two TRPs (labeled “TRP1” and “TRP2”) operating in the same positioning frequency layer (labeled “Positioning Frequency Layer 1”), according to aspects of the disclosure. For a positioning session, a UE may be provided with assistance data indicating the illustrated PRS configuration. In the example of FIG. 7, the first TRP (“TRP1”) is associated with (e.g., transmits) two PRS resource sets, labeled “PRS Resource Set 1” and “PRS Resource Set 2,” and the second TRP (“TRP2”) is associated with one PRS resource set, labeled “PRS Resource Set 3.” Each PRS resource set comprises at least two PRS resources. Specifically, the first PRS resource set (“PRS Resource Set 1”) includes PRS resources labeled “PRS Resource 1” and “PRS Resource 2,” the second PRS resource set (“PRS Resource Set 2”) includes PRS resources labeled “PRS Resource 3” and “PRS Resource 4,” and the third PRS resource set (“PRS Resource Set 3”) includes PRS resources labeled “PRS Resource 5” and “PRS Resource 6.”

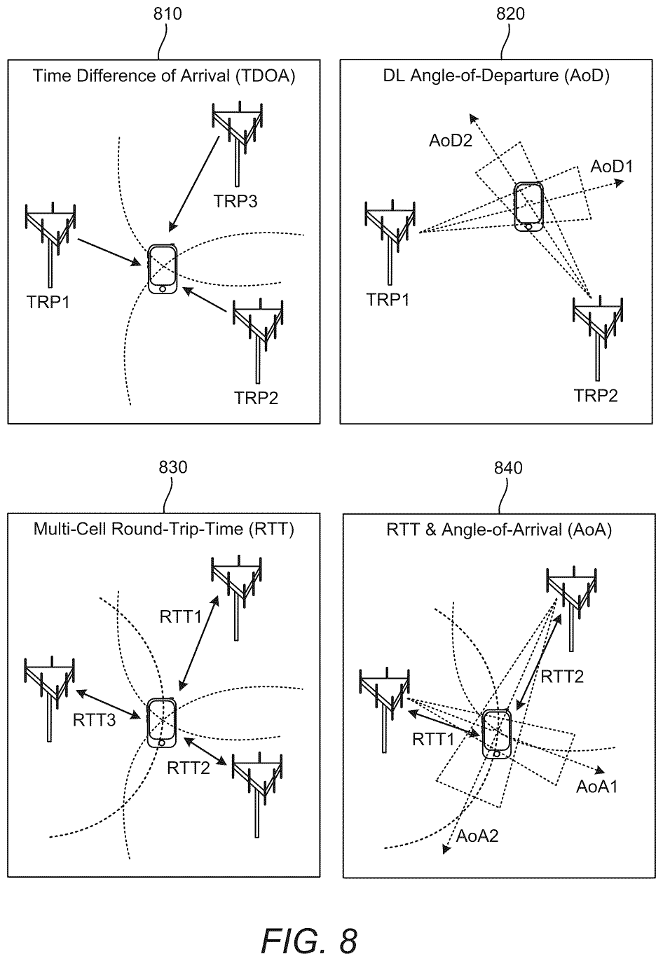

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 8 illustrates examples of various positioning methods, according to aspects of the disclosure. In an OTDOA or DL-TDOA positioning procedure, illustrated by scenario 810, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 820, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 830, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 840.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

Even when there is no traffic being transmitted from the network to a UE, the UE is expected to monitor every downlink subframe on the physical downlink control channel (PDCCH). This means that the UE has to be “on,” or active, all the time, even when there is no traffic, since the UE does not know exactly when the network will transmit data for it. However, being active all the time is a significant power drain for a UE.

To address this issue, a UE may implement discontinuous reception (DRX) and/or connected-mode discontinuous reception (CDRX) techniques. DRX and CDRX are mechanisms in which a UE goes into a “sleep” mode for a scheduled periods of time and “wakes up” for other periods of time. During the wake, or active, periods, the UE checks to see if there is any data coming from the network, and if there is not, goes back into sleep mode.

To implement DRX and CDRX, the UE and the network need to be synchronized. In a worst-case scenario, the network may attempt to send some data to the UE while the UE is in sleep mode, and the UE may wake up when there is no data to be received. To prevent such scenarios, the UE and the network should have a well-defined agreement about when the UE can be in sleep mode and when the UE should be awake/active. This agreement has been standardized in various technical specifications. Note that DRX includes CDRX, and thus, references to DRX refer to both DRX and CDRX, unless otherwise indicated.

The network (e.g., serving cell) can configure the UE with the DRX/CDRX timing using an RRC Connection Reconfiguration message (for CDRX) or an RRC Connection Setup message (for DRX). The network can signal the following DRX configuration parameters to the UE. (1) DRX Cycle: The duration of one ‘ON time’ plus one ‘OFF time.’ This value is not explicitly specified in RRC messages; rather, it is calculated by the subframe/slot time and “long DRX cycle start offset.” (2) ON Duration Timer: The duration of ‘ON time’ within one DRX cycle. (3) DRX Inactivity Timer: How long a UE should remain ‘ON’ after the reception of a PDCCH. When this timer is on, the UE remains in the ‘ON state,’ which may extend the ON period into the period that would be the ‘OFF’ period otherwise. (4) DRX Retransmission Timer: The maximum number of consecutive PDCCH subframes/slots a UE should remain active to wait for an incoming retransmission after the first available retransmission time. (5) Short DRX Cycle: A DRX cycle that can be implemented within the ‘OFF’ period of a long DRX cycle. (6) DRX Short Cycle Timer: The consecutive number of subframes/slots that should follow the short DRX cycle after the DRX inactivity timer has expired.

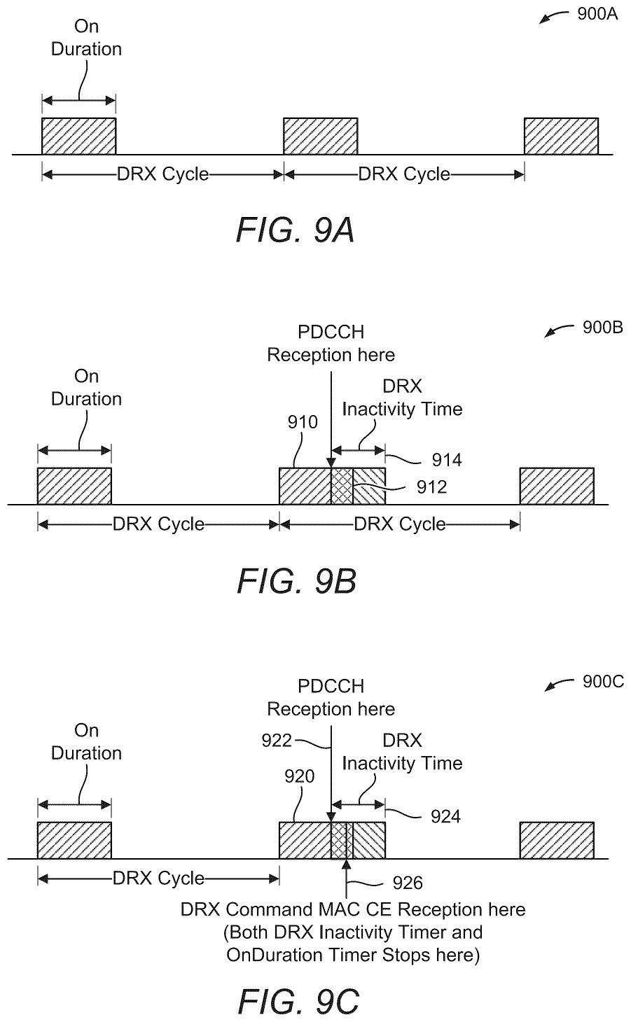

FIGS. 9A to 9C illustrate example DRX configurations, according to aspects of the disclosure. FIG. 9A illustrates an example DRX configuration 900A in which a long DRX cycle (the time from the start of one ON duration to the start of the next ON duration) is configured and no PDCCH is received during the cycle. FIG. 9B illustrates an example DRX configuration 900B in which a long DRX cycle is configured and a PDCCH is received during an ON duration 910 of the second DRX cycle illustrated. Note that the ON duration 910 ends at time 912. However, the time that the UE is awake/active (the “active time”) is extended to time 914 based on the length of the DRX inactivity timer and the time at which the PDCCH is received. Specifically, when the PDCCH is received, the UE starts the DRX inactivity timer and stays in the active state until the expiration of that timer (which is reset each time a PDCCH is received during the active time).

FIG. 9C illustrates an example DRX configuration 900C in which a long DRX cycle is configured and a PDCCH and a DRX command MAC control element (MAC-CE) are received during an ON duration 920 of the second DRX cycle illustrated. Note that the active time beginning during ON duration 920 would normally end at time 924 due to the reception of the PDCCH at time 922 and the subsequent expiration of the DRX inactivity timer at time 924, as discussed above with reference to FIG. 9B. However, in the example of FIG. 9C, the active time is shortened to time 926 based on the time at which the DRX command MAC-CE, which instructs the UE to terminate the DRX inactivity timer and the ON duration timer, is received.

In greater detail, the active time of a DRX cycle is the time during which the UE is considered to be monitoring the PDCCH. The active time may include the time during which the ON duration timer is running, the DRX inactivity timer is running, the DRX retransmission timer is running, the MAC contention resolution timer is running, a scheduling request has been sent on the PUCCH and is pending, an uplink grant for a pending HARQ retransmission can occur and there is data in the corresponding HARQ buffer, or a PDCCH indicating a new transmission addressed to the cell radio network temporary identifier (C-RNTI) of the UE has not been received after successful reception of a random access response (RAR) for the preamble not selected by the UE. And, in non-contention-based random access, after receiving the RAR, the UE should be in an active state until the PDCCH indicating new transmission addressed to the C-RNTI of the UE is received.

In order to establish uplink synchronization and a radio resource control (RRC) connection with a base station (or more specifically, a serving cell/TRP), a UE needs to perform a random access procedure (also referred to as a random access channel (RACH) procedure or a physical random access channel (PRACH) procedure). There are two types of random access available in NR, contention based random access (CBRA), also referred to as “four-step” random access, and contention free random access (CFRA), also referred to as “three-step” random access. There is also a “two-step” random access procedure that may be performed instead of the four-step random access procedure in certain cases.

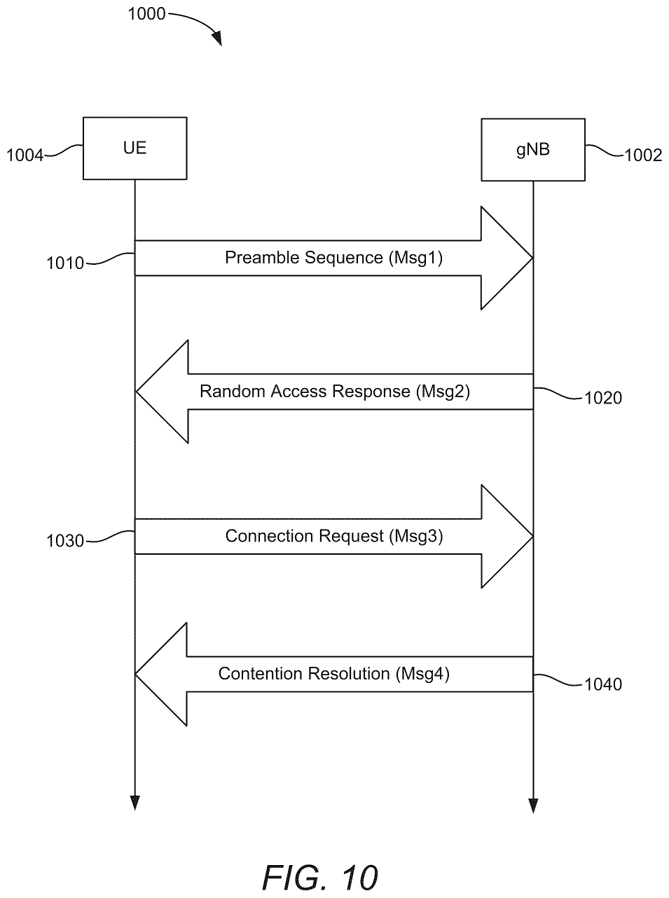

FIG. 10 illustrates an example four-step random access procedure 1000, according to aspects of the disclosure. The four-step random access procedure 1000 is performed between a UE 1004 and a base station 1002 (illustrated as a gNB), which may correspond to any of the UEs and base stations, respectively, described herein.

There are various situations in which a UE 1004 may perform the four-step random access procedure 1000. For example, a UE 1004 may perform the four-step random access procedure 1000 when performing an initial RRC connection setup (i.e., acquiring initial network access after coming out of the RRC IDLE state), when performing an RRC connection re-establishment procedure, when the UE 1004 has uplink data to transmit, when the UE 1004 has uplink data to transmit and the UE 1004 is in an RRC CONNECTED state but there are no PUCCH resources available for a scheduling request (SR), or when there is a scheduling request failure.

Before performing the four-step random access procedure 1000, the UE 1004 reads one or more synchronization signal blocks (SSBs) broadcasted by the base station 1002 with which the UE 1004 is performing the four-step random access procedure 1000. In NR, each beam transmitted by a base station (e.g., base station 1002) is associated with a different SSB, and a UE (e.g., UE 1004) selects a certain beam to use to communicate with the base station 1002. Based on the SSB of the selected beam, the UE 1004 can then read the system information block (SIB) type 1 (SIB1), which carries cell access related information and supplies the UE 1004 with the scheduling of other system information blocks transmitted on the selected beam.

When the UE 1004 sends the very first message of the four-step random access procedure 1000 to the base station 1002, it sends a specific pattern called a “preamble” (also referred to as a “RACH preamble,” a “PRACH preamble,” a “sequence”). The preamble differentiates requests from different UEs 1004. In CBRA, a UE 1004 selects a preamble randomly from a pool of preambles (64 in NR) shared with other UEs 1004. However, if two UEs 1004 use the same preamble at the same time, then there can be a collision, or contention.

Thus, at 1010, the UE 1004 selects one of the 64 preambles to send to the base station 1002 as a RACH request (also referred to as a “random access request”). This message is referred to as “Message 1” or “Msg1” in a four-step random access procedure 1000. Based on the synchronization information from the base station 1002 (e.g., the SIB1), the UE 1004 sends the preamble at the RACH occasion (RO) corresponding to the selected SSB/beam. More specifically, in order for the base station 1002 to determine which beam the UE 1004 has selected, a specific mapping is defined between an SSB and an RO (which occur every 10, 20, 40, 80, or 160 ms). By detecting at which RO the UE 1004 sent the preamble, the base station 1002 can determine which SSB/beam the UE 1004 selected.

Note that an RO is a time-frequency transmission opportunity for transmitting a preamble, and a preamble index (i.e., a value from 0 to 63 for the 64 possible preambles) enables the UE 1004 to generate the type of preamble expected at the base station 1002. The RO and preamble index may be configured to the UE 1004 by the base station 1002 in a SIB. A RACH resource is an RO in which one preamble index is transmitted. As such, the terms “RO” (or “RACH occasion”) and “RACH resource” may be used interchangeably, depending on the context.

Due to reciprocity, the UE 1004 may use the uplink transmit beam corresponding to the best downlink receive beam determined during synchronization (i.e., the best receive beam to receive the selected downlink beam from the base station 1002). That is, the UE 1004 uses the parameters of the downlink receive beam used to receive the SSB beam from the base station 1002 to determine the parameters of the uplink transmit beam. If reciprocity is available at the base station 1002, the UE 1004 can transmit the preamble over one beam. Otherwise, the UE 1004 repeats transmission of the same preamble on all of its uplink transmit beams.

The UE 1004 also needs to provide its identity to the network (via base station 1002) so that the network can address it in the next step. This identity is called the random access radio network temporary identity (RA-RNTI) and is determined from the time slot in which the preamble is sent.

If the UE 1004 does not receive a response from the base station 1002 within some period of time, it increases its transmission power by a fixed step and sends the preamble/Msg1 again. More specifically, the UE 1004 transmits a first set of repetitions of the preamble, then, if it does not receive a response, it increases its transmission power and transmits a second set of repetitions of the preamble. The UE 1004 continues increasing its transmit power in incremental steps until it receives a response from the base station 1002.

At 1020, the base station 1002 sends a random access response (RAR), referred to as a “Message 2” or “Msg2” in a four-step random access procedure 1000, to the UE 1004 on the selected beam. The RAR is sent on a physical downlink shared channel (PDSCH) and is addressed to the RA-RNTI calculated from the time slot (i.e., RO) in which the preamble was sent. The RAR carries the following information: a cell-radio network temporary identifier (C-RNTI), a timing advance (TA) value, and an uplink grant resource. The base station 1002 assigns the C-RNTI to the UE 1004 to enable further communication with the UE 1004. The TA value specifies how much the UE 1004 should change its timing to compensate for the propagation delay between the UE 1004 and the base station 1002. The uplink grant resource indicates the initial resources the UE 1004 can use on the physical uplink shared channel (PUSCH). After this step, the UE 1004 and the base station 1002 establish coarse beam alignment that can be utilized in the subsequent steps.

At 1030, using the allocated PUSCH, the UE 1004 sends an RRC connection request message, referred to as a “Message 3” or “Msg3,” to the base station 1002. Because the UE 1004 sends the Msg3 over the resources scheduled by the base station 1002, the base station 1002 knows from where (spatially) to detect the Msg3 and therefore which uplink receive beam should be used. Note that the Msg3 PUSCH can be sent on the same or different uplink transmit beam as the Msg1.

The UE 1004 identifies itself in the Msg3 by the C-RNTI assigned in the previous step. The message contains the UE's 1004 identity and connection establishment cause. The UE's 1004 identity is either a temporary mobile subscriber identity (TMSI) or a random value. A TMSI is used if the UE 1004 has previously connected to the same network. The UE 1004 is identified in the core network by the TMSI. A random value is used if the UE 1004 is connecting to the network for the very first time. The reason for the random value or TMSI is that the C-RNTI may have been assigned to more than one UE 1004 in the previous step, due to multiple requests arriving at the same time. The connection establishment cause indicates the reason why the UE 1004 needs to connect to the network (e.g., for a positioning session, because it has uplink data to transmit, because it received a page from the network, etc.).

As noted above, the four-step random access procedure 1000 is a CBRA procedure. Thus, as described above, any UE 1004 connecting to the same base station 1002 can send the same preamble at 1010, in which case, there is a possibility of collision, or contention, among the requests from the various UEs 1004. Accordingly, the base station 1002 uses a contention resolution mechanism to handle this type of access request. In this procedure, however, the result is random and not all random access succeeds.

Thus, at 1040, if the Msg3 was successfully received, the base station 1002 responds with a contention resolution message, referred to as a “Message 4” or “Msg4.” This message is addressed to the TMSI or random value (from the Msg3) but contains a new C-RNTI that will be used for further communication. Specifically, the base station 1002 sends the Msg4 in the PDSCH using the downlink transmit beam determined in the previous step.

As shown in FIG. 10, the four-step random-access procedure 1000 requires two round-trip cycles between the UE 1004 and the base station 1002, which not only increases latency but also incurs additional control signaling overhead. To address these issues, two-step random access has been introduced in NR for CBRA. The motivation behind two-step random access is to reduce latency and control signaling overhead by having a single round trip cycle between a UE and a base station. This is achieved by combining the preamble (Msg1) and the scheduled PUSCH transmission (Msg3) into a single message from the UE to the base station, known as “MsgA.” Similarly, the random access response (Msg2) and the contention resolution message (Msg4) are combined into a single message from the base station to the UE, known as “MsgB.” This reduces latency and control signaling overhead.

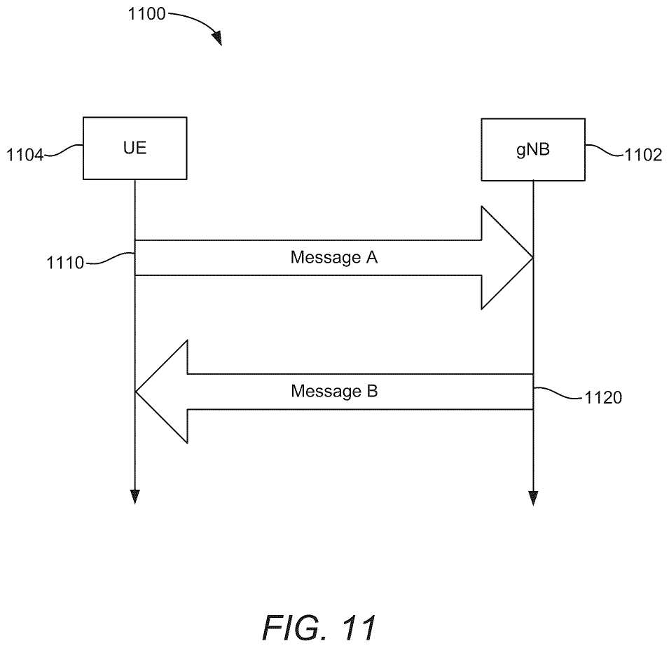

FIG. 11 illustrates an example two-step random access procedure 1100, according to aspects of the disclosure. The two-step random access procedure 1100 may be performed between a UE 1104 and a base station 1102 (illustrated as a gNB), which may correspond to any of the UEs and base stations, respectively, described herein.

At 1110, the UE 1104 transmits a RACH Message A (“MsgA”) to the base station 1102. In a two-step random access procedure 1100, Msg1 and Msg3, described above with reference to FIG. 10, are collapsed (i.e., combined) into a MsgA and sent to the base station 1102. As such, a MsgA includes a preamble and a PUSCH similar to the Msg3 PUSCH of a four-step random access procedure 1000. The preamble may have been selected from the 64 possible preambles, as described above with reference to FIG. 10, and may be used as a reference signal for demodulating the data transmitted in the MsgA. At 1120, the UE 1104 receives a RACH Message B (“MsgB”) from the base station 1102. The MsgB may be a combination of Msg2 and Msg4 described above with reference to FIG. 10.

The combination of Msg1 and Msg3 into one MsgA and the combination of Msg2 and Msg4 into one MsgB allows the UE 1104 to reduce the RACH procedure setup time to support the low-latency requirements of NR. Although the UE 1104 may be configured to support the two-step random access procedure 1100, the UE 1104 may still support the four-step random access procedure 1000 as a fall back if the UE 1104 is not able to use the two-step random access procedure 1100 due to some constraints (e.g., high transmit power requirements, etc.). Therefore, a UE 1104 in NR may be configured to support both the four-step and the two-step random access procedures 1000 and 1100, and may determine which random access procedure to use based on the RACH configuration information received from the base station 1102.

In some designs, DL-PRS processing Average Power Consumption per slot (P_{fr}) may be as follows:

TABLE 1
DL-PRS processing Average Power Consumption per slot (P_{fr})

| | Value |
|---|---|
| Scenario | (P_{fr}) |
| Serving cell SSB or CSI-RS processing, 30 KHz SCS, | 100 |
| System BW 100 MHz, Single-CC, Table 18 of 38.840 | |
| Intra-frequency RRM measurement, 8 TRPs, 2 SSBs | 150 |
| per slot, Synchronous (Table 22 of 38.840) | |
| Intra-frequency RRM measurement, 8 TRPs, 2 SSBs | 200 |
| per slot, combined neighbor cell measurements | |
| and cell search (Table 24 of 38.840) | |
| PRS Measurement, 8 TRPs, 30 KHz SCS, 6 ms PRS | 200 |
| length, 100 MHz (Huawei, R1-2007576) | |
| PRS Measurement, 8 TRPs, 30 KHz SCS, 4 ms PRS | 610 |
| length, 100 MHz (vivo, R1-2007664) | |

In some designs, C-DRX cycle 160 msec and I-DRX cycle of 1.28 sec may be implemented, with an 8 msec ON-duration timer and 100 msec inactivity timer, and 30 KHz SCS, 100 MHz PRS/SRS. In some designs, no data traffic is assumed in the power cycle computation.

In some designs, relative UE power consumption in various states of operation may be as follows:

TABLE 2
Relative UE Power Consumption

| | Relative Power | Relative Power |
|---|---|---|
| | (100 MHz, | (Idle/Inactive with |
| Power State | 30 MHz SCS) | BW = 20 MHz) |
| Deep Sleep (P_{DS}) | 1 | 1 |
| Light Sleep (P_{LS}) | 20 | 20 |
| Micro sleep (P_{MS}) | 45 | 45 |
| PDCCH-only (P_{PDCCH}) | 100 | 50 |
| PDCCH + PDSCH | 300 | 120 |
| SSB serv. cell | 100 | 50 |

| | |
|---|---|
| Long PUSCH Tx | 250 (0 dBm), 700 (23 dBm) |
| SRS Tx | 0.3*UL Power |
| PRACH | 175 |

whereby power scaling to 20 MHz reception BW according to the rule in Section 8.1.3 of TR 38.840: max {reference power*0.4, 50}.

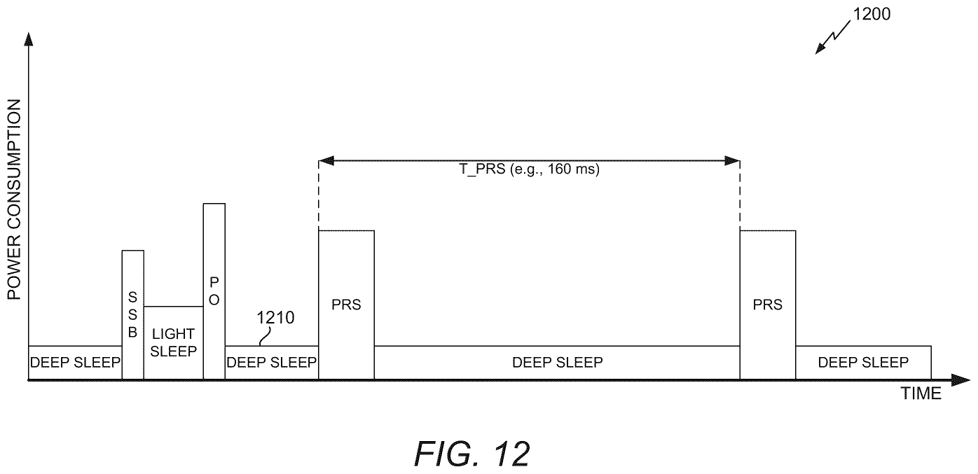

FIG. 12 illustrates an RRC Idle/Inactive PRS processing scheme 1200, in accordance with aspects of the disclosure. Referring to FIG. 12, a paging occasion (PO) is scheduled separately from periodic PRS. Hence, a deep sleep period 1210 occurs between PO and PRS instance. In some designs, UE power consumption during the RRC Idle/Inactive PRS processing scheme 1200 may be as follows:

TABLE 3
Relative UE Power Consumption for RRC Idle/Inactive

| RRC Idle/Inactive PRS | Power Unit | # Slot(s) |
|---|---|---|
| Paging Occasion (2 ms) | 57 | 4 |
| SSB Serving Cell (2 ms) | 50 | 4 |
| Light Sleep | 20 | 16 |
| PRS Instance (4 ms) | P_{PRS} | 64 |
| Deep Sleep | 1 | 2472 |
| Deep State Transition | 450 | 9 Transitions |
| Light State Transition | 100 | 1 Transition |

whereby power unit 57 for Paging Occasion (2 ms) assumes a Paging rate of 50*0.8+120*0.1=57, and #slots=16 for Light Sleep assumes an average gap of SSB to PDCCH of 10 ms.

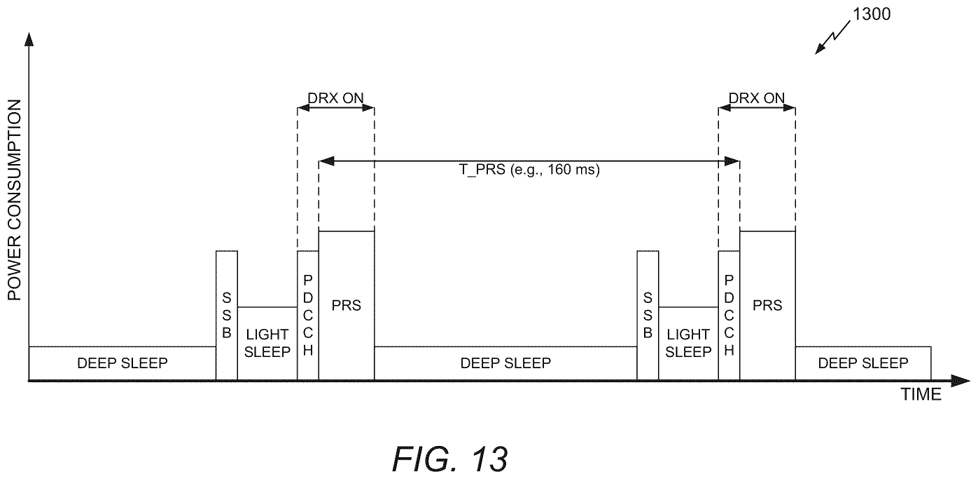

FIG. 13 illustrates an RRC Connected PRS processing scheme 1300 for PRS inside DRX ON duration, in accordance with aspects of the disclosure. Referring to FIG. 13, because the UE is RRC Connected, PRS is performed directly after PDCCH without an intervening sleep state (light sleep or deep sleep). In some designs, UE power consumption during the RRC Connected PRS processing scheme 1300 for PRS inside DRX ON duration may be as follows:

TABLE 4
Relative UE Power Consumption for RRC Connected
for PRS inside DRX ON duration

| RRC Idle/Inactive PRS | Power Unit | # Slot(s) |
|---|---|---|
| SSB Serving Cell (2 ms) | 100 | 32 |
| Light Sleep | 20 | 128 |
| PDCCH-only Monitoring (3 ms) | 100 | 48 |
| PRS Instance (4 ms) within a | P_{PRS} | 64 |
| Measurement Gap (MG) | | |
| Deep Sleep | 1 | 2280 |
| Deep State Transition | 450 | 8 Transitions |
| Light State Transition | 100 | 8 Transitions |

whereby #slots=128 for Light Sleep assumes an average gap of SSB to PDCCH of 10 ms.

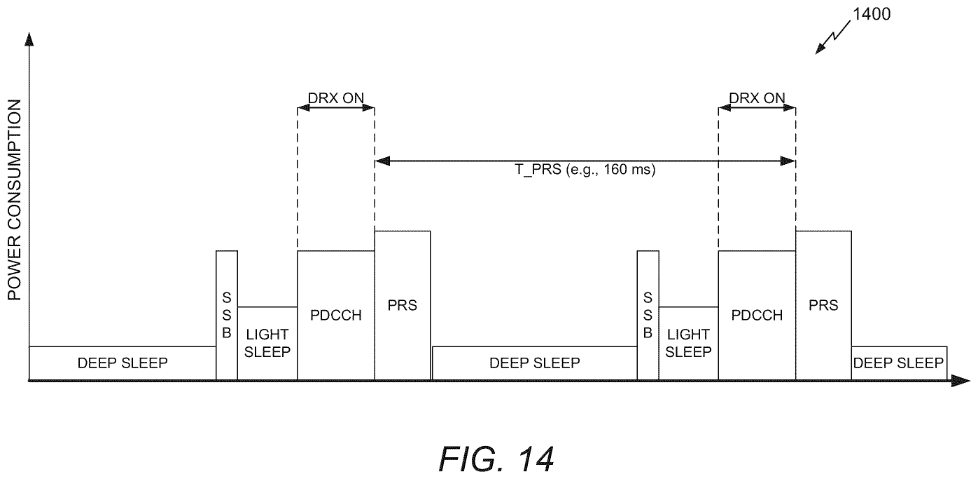

FIG. 14 illustrates an RRC Connected PRS processing scheme 1400 for PRS outside DRX ON duration, in accordance with aspects of the disclosure. Referring to FIG. 14, because the UE is RRC Connected, PRS is performed directly after PDCCH without an intervening sleep state (light sleep or deep sleep). In some designs, UE power consumption during the RRC Connected PRS processing scheme 1400 for PRS outside DRX ON duration may be as follows:

TABLE 5
Relative UE Power Consumption for RRC Connected
for PRS outside DRX ON duration

| RRC Idle/Inactive PRS | Power Unit | # Slot(s) |
|---|---|---|
| SSB Serving Cell (2 ms) | 100 | 32 |
| Light Sleep | 20 | 128 |
| PDCCH-only Monitoring (8 ms) | 100 | 128 |
| PRS Instance (4 ms) within a | P_{PRS} | 64 |
| Measurement Gap (MG) | | |
| Deep Sleep | 1 | 2200 |
| Deep State Transition | 450 | 8 Transitions |
| Light State Transition | 100 | 8 Transitions |

whereby #slots=128 for Light Sleep assumes an average gap of SSB to PDCCH of 10 ms.

Referring to FIGS. 12-14, PRS processing in RRC Idle/Inactive may result to 20% to 35% power savings over PRS processing in CDRX On Duration. These gains may be mainly due to significantly less PDCCH monitoring in RRC Idle/Inactive.

In some designs, POs may be configured in several locations so that different UEs are TDMed when the respective UEs' are monitoring paging. In some designs (e.g., 3GPP TS 38.213), the UE may use Discontinuous Reception (DRX) in RRC_IDLE and RRC_INACTIVE state in order to reduce power consumption. In some designs, the UE monitors one paging occasion (PO) per DRX cycle. In an example, a PO is a set of PDCCH monitoring occasions and can include multiple time slots (e.g. subframe or OFDM symbol) where paging DCI can be sent (e.g., see 3GPP TS 38.213). In an example, a Paging Frame (PF) is one Radio Frame and may contain one or multiple PO(s) or starting point of a PO.

In some designs, the system frame number (SFN) for the PF is determined by:

(SFN+PF_offset)mod T=(T div N)*(UE_ID mod N) Equation 1

and an index (I_s) indicating the index of the PO is determined by:

i_s=floor(UE_ID/N)mod Ns Equation 2

whereby:
T: DRX cycle of the UE (T is determined by the shortest of the UE specific DRX value(s), if configured by RRC and/or upper layers, and a default DRX value broadcast in system information. In RRC_IDLE state, if UE specific DRX is not configured by upper layers, the default value is applied).
N: number of total paging frames in T
Ns: number of paging occasions for a PF
PF_offset: offset used for PF determination
UE_ID: 5G-S-TMSI mod 1024

In some designs, Equation 2 is used such that different UEs wake up on different slots and/or subframes for monitoring their respective POs. In some designs, parameters Ns, nAndPagingFrameOffset, and the length of default DRX Cycle are signaled in SIB1. The values of N and PF_offset are derived from the parameter nAndPagingFrameOffset as pre-defined (e.g., in 3GPP TS 38.331). The parameter first-PDCCH-MonitoringOccasionOfPO is signaled in SIB1 for paging in initial DL BWP. For paging in a DL BWP other than the initial DL BWP, the parameter first-PDCCH-MonitoringOccasionOfPO is signaled in the corresponding BWP configuration. If the UE has no 5G-S-TMSI, for instance when the UE has not yet registered onto the network, the UE shall use as default identity UE_ID=0 in the PF and i_s formulas above.

As noted above, POs are generally scheduled without regard to when periodic PRS are scheduled. Hence, in some scenarios, the UE may enter into a sleep state between a first wakeup for PO monitoring and a second wakeup for measurement(s) of a PRS instance, as shown above with respect to 1210 of FIG. 12. Aspects of the disclosure are thereby directed to a scheduling scheme whereby a PO is scheduled based at least in part upon a PRS configuration (or more specifically, based upon a particular PRS instance of the PRS configuration). In some designs, respective windows of time for PO and for PRS instance can be TDMed back-to-back so as to avoid a sleep state (e.g., light sleep state or deep sleep state) between the PO and the PRS instance. Such aspects may provide various technical advantages, such as reducing UE power consumption by reducing the number of wakeup transitions (e.g., DRX OFF to DRX ON) and sleep state transitions (e.g., DRX ON to DRX OFF).

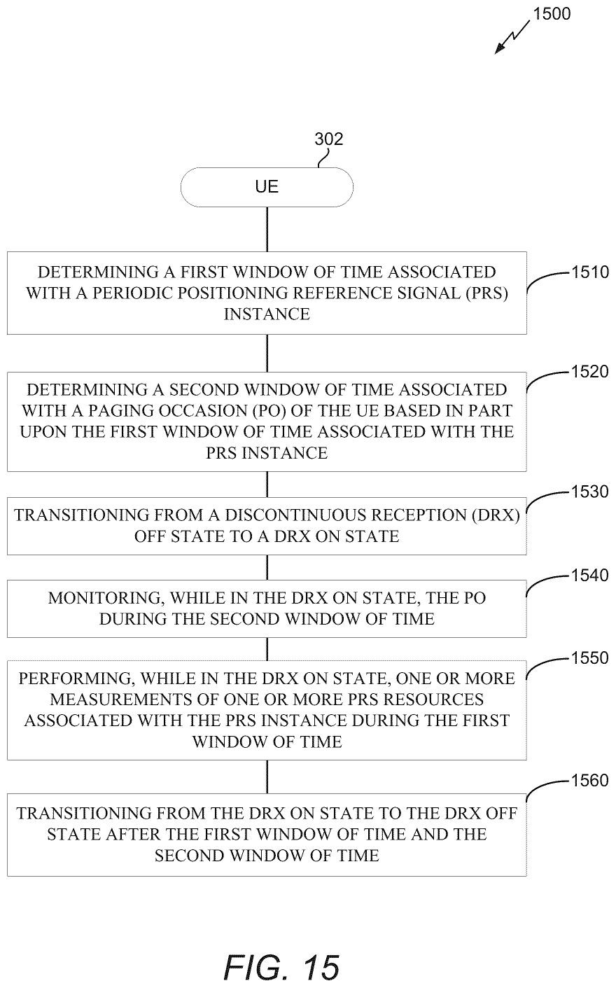

FIG. 15 illustrates an exemplary process 1500 of wireless communication, according to aspects of the disclosure. In an aspect, the process 1500 may be performed by a UE, such as UE 302. In some designs, the process 1500 may be performed by UE 302 while UE 302 is in RRC Inactive state or RRC Idle state.

Referring to FIG. 15, at 1510, UE 302 (e.g., processor(s) 332, scheduling module 342, etc.) determines a first window of time associated with a periodic PRS instance. For example, the first window of time may be determined based on a PRS configuration associated with the PRS instance.

Referring to FIG. 15, at 1520, UE 302 (e.g., processor(s) 332, scheduling module 342, etc.) determines a second window of time associated with a PO of the UE based in part upon the first window of time associated with the PRS instance. As explained above, this is contrary to operation in current systems which generally determine the PO window based on Equations 1-2 as depicted above.

Referring to FIG. 15, at 1530, UE 302 (e.g., receiver 312 or 322, transmitter 314 or 324, processor(s) 332, scheduling module 342, etc.) transitions from a DRX OFF state to a DRX ON state. In other words, UE 302 wakes up certain RF circuitry at 1530 so as to perform reception and/or measurement of PO and/or PRS.

Referring to FIG. 15, at 1540, UE 302 (e.g., receiver 312 or 322, processor(s) 332, scheduling module 342, etc.) monitors, while in the DRX ON state, the PO during the second window of time.

Referring to FIG. 15, at 1550, UE 302 (e.g., receiver 312 or 322, processor(s) 332, scheduling module 342, etc.) performs, while in the DRX ON state, one or more measurements (e.g., Rx-Tx, TOA, TDOA. RSRP. RSTD, etc.) of one or more PRS resources associated with the PRS instance during the first window of time.

Referring to FIG. 15, at 1560. UE 302 (e.g., receiver 312 or 322, transmitter 314 or 324, processor(s) 332, scheduling module 342, etc.) transitions from the DRX ON state to the DRX OFF state after the first window of time and the second window of time. In other words, UE 302 re-enters a sleep state by turning off certain RF circuitry at 1530 so as to save power.

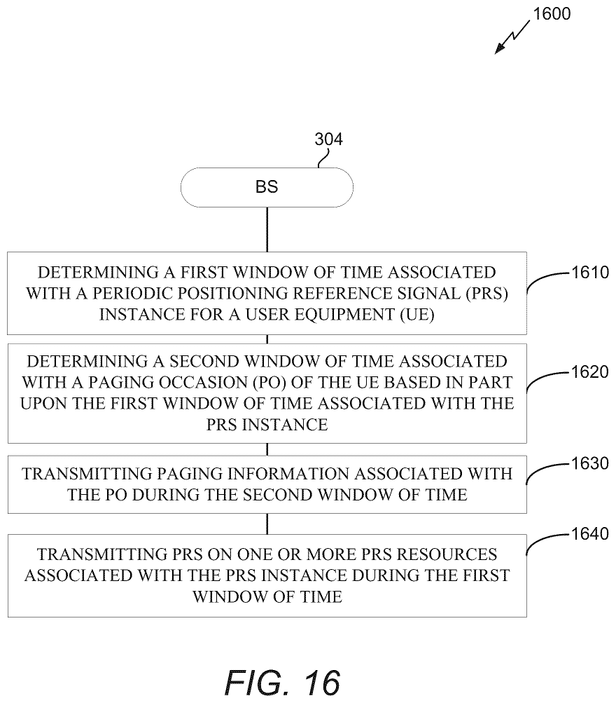

FIG. 16 illustrates an exemplary process 1600 of wireless communication, according to aspects of the disclosure. In an aspect, the process 1600 may be performed by a BS (e.g., gNB, TRP, etc.), such as BS 304. In some designs, the process 1600 may be performed by BS 304 while an associated UE is in RRC Inactive state or RRC Idle state.

Referring to FIG. 16, at 1610, BS 304 (e.g., processor(s) 384, scheduling module 388, etc.) determines a first window of time associated with a periodic positioning reference signal (PRS) instance for a user equipment (UE). For example, the first window of time may be determined based on a PRS configuration associated with the PRS instance.

Referring to FIG. 16, at 1620, BS 304 (e.g., processor(s) 384, scheduling module 388, etc.) determines a second window of time associated with a paging occasion (PO) of the UE based in part upon the first window of time associated with the PRS instance. As explained above, this is contrary to operation in current systems which generally determine the PO window based on Equations 1-2 as depicted above.

Referring to FIG. 16, at 1630, BS 304 (e.g., transmitter 354 or 364, etc.) transmits paging information associated with the PO during the second window of time. For example, the paging information may indicate that data is available for transmission to the UE, or alternatively that no data is available for transmission to the UE.

Referring to FIG. 16, at 1640. BS 304 (e.g., transmitter 354 or 364, etc.) transmits PRS on one or more PRS resources associated with the PRS instance during the first window of time.

Referring to FIGS. 15-16, in some designs, the first window of time follows the second window of time. In other words, UE 302 may wake up and first receive/decode the PO, and may then measure the PRS resource(s) of the PRS instance without an intervening sleep state (or DRX OFF) transition.

Referring to FIGS. 15-16, in some designs, a gap between a time gap between the first window of time and the second window of time is less than a threshold, or the first window of time and the second window of time are adjacent without an intervening time gap.

Referring to FIGS. 15-16, in some designs, UE 302 may transmit, to BS 304, a request for the PO to be scheduled during the second window of time. For example, the request may indicate the second window of time via an input offset to a PO scheduling algorithm that is used to derive timing of the PO. In a specific example, the input offset may be applied as an offset to the UE ID, as follows:

i_s=floor((UE_ID+Offset)/N)mod Ns Equation 3

In other designs, the request may indicate the second window of time via an output offset from the PO scheduling algorithm. In other words, the offset may be a direct offset to i_s, rather than an Offset applied to a particular input parameter (e.g., UE ID) to the i_s algorithm.

Referring to FIGS. 15-16, in some designs, the second window of time for the PO is determined implicitly based on knowledge of the PRS instance and an initial window of time associated with the PO. For example, BS 304 has knowledge of the PRS instance and a current scheduling of the PO. Based on this information, BS 304 may pick a PO to be monitored based on the PRS instance so as to ensure the PO and PRS instance are close together in time so a sleep state transition between the PO and PRS instance can be avoided.

Referring to FIGS. 15-16, in some designs, the request may correspond to:
a Msg3 PUSCH (e.g., in payload of Msg3 PUSCH for 4-Step RACH), or
a MsgA PUSCH (e.g., in payload of MsgA PUSCH for 2-Step RACH), or
an uplink control information (UCI) multiplexed with PUSCH (e.g., granted by RAR, or pre-configured by RRC) together with UE ID (e.g., 5G-S-TMSI mod 1024), or
a Msg3 PUSCH demodulation reference signal (DMRS) resource, or
a dedicated physical random access channel (PRACH) preamble (e.g., used to indicate that the UE will wake up on a PO that is closest in proximity with a configured PRS instance, etc.), or
any combination thereof.

Note that in some standards, the UE is expected to wake up in the PO that is closest in time to the PRS instance. In this case, in an example, the PRS instance that should be assumed for that purpose, should be the one with highest priority as appearing in the assistance data: The PRS instance may correspond to the PRS instance from the PFL with the highest priority and the highest priority set of this PFL.

Referring to FIGS. 15-16, in some designs, the second window of time is configured by a network component (e.g., in contrast to the second window of time being requested by the UE itself).

Referring to FIGS. 15-16, in some designs, BS 304 may receive, from a LMF, a request for the PO to be scheduled during the second window of time. For example, the LMF may send a request to the serving gNB to configure the UE with the new technique of picking the PO (e.g., the LMF may ask for specific PO/slot-offsets/subframes/frames to be used for PO monitoring, etc.).

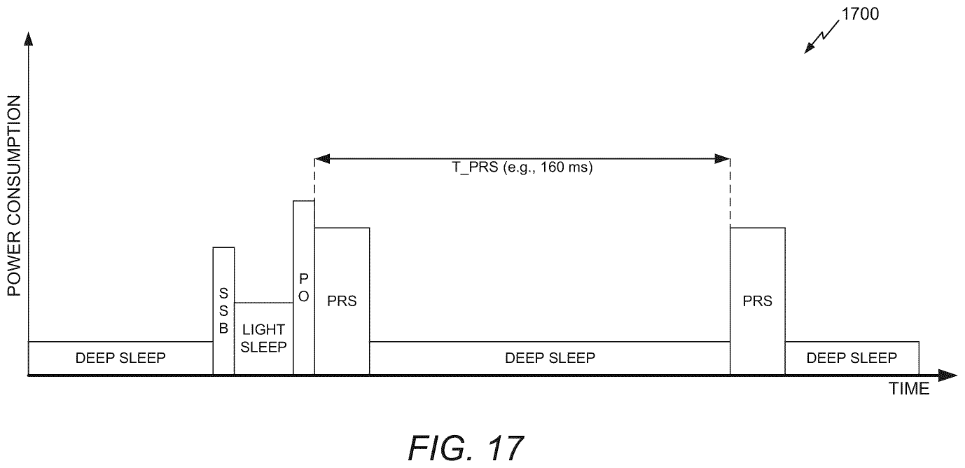

FIG. 17 illustrates an example implementation 1700 of FIGS. 15-16, in accordance with aspects of the disclosure. In particular, FIG. 17 depicts a variation to the RRC Idle/Inactive PRS processing scheme 1200 described above with respect to FIG. 12. As shown in FIG. 17, in an example, the PRS instance may be scheduled directly after the PO, such that the sleep state transition at 1210 can be avoided, thereby reducing UE power consumption.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an insulator and a conductor). Furthermore, it is also intended that aspects of a clause can be included in any other independent clause, even if the clause is not directly dependent on the independent clause.

Implementation examples are described in the following numbered clauses:

Clause 1. A method of operating a user equipment (UE), comprising: determining a first window of time associated with a periodic positioning reference signal (PRS) instance; determining a second window of time associated with a paging occasion (PO) of the UE based in part upon the first window of time associated with the PRS instance; transitioning from a discontinuous reception (DRX) OFF state to a DRX ON state; monitoring, while in the DRX ON state, the PO during the second window of time; performing, while in the DRX ON state, one or more measurements of one or more PRS resources associated with the PRS instance during the first window of time; and transitioning from the DRX ON state to the DRX OFF state after the first window of time and the second window of time.

Clause 2. The method of clause 1, wherein the first window of time follows the second window of time.

Clause 3. The method of any of clauses 1 to 2, wherein a gap between a time gap between the first window of time and the second window of time is less than a threshold, or wherein the first window of time and the second window of time are adjacent without an intervening time gap.

Clause 4. The method of any of clauses 1 to 3, further comprising: transmitting, to a base station, a request for the PO to be scheduled during the second window of time.

Clause 5. The method of clause 4, wherein the request indicates the second window of time via an input offset to a PO scheduling algorithm that is used to derive timing of the PO, or wherein the request indicates the second window of time via an output offset from the PO scheduling algorithm, or a combination thereof.

Clause 6. The method of any of clauses 4 to 5, wherein the request corresponds to a Msg3 physical uplink shared channel (PUSCH), or wherein the request corresponds to a MsgA PUSCH, or wherein the request corresponds to an uplink control information (UCI) multiplexed with PUSCH, or wherein the request corresponds to a Msg3 PUSCH demodulation reference signal (DMRS) resource, or wherein the request corresponds to a dedicated physical random access channel (PRACH) preamble, or any combination thereof.

Clause 7. The method of any of clauses 1 to 6, wherein the second window of time for the PO is determined implicitly based on knowledge of the PRS instance and an initial window of time associated with the PO.

Clause 8. The method of any of clauses 1 to 7, wherein the second window of time is configured by a network component.

Clause 9. A method of operating a base station, comprising: determining a first window of time associated with a periodic positioning reference signal (PRS) instance for a user equipment (UE); determining a second window of time associated with a paging occasion (PO) of the UE based in part upon the first window of time associated with the PRS instance; transmitting paging information associated with the PO during the second window of time; and transmitting PRS on one or more PRS resources associated with the PRS instance during the first window of time.

Clause 10. The method of clause 9, wherein the first window of time follows the second window of time.

Clause 11. The method of any of clauses 9 to 10, wherein a gap between a time gap between the first window of time and the second window of time is less than a threshold, or wherein the first window of time and the second window of time are adjacent without an intervening time gap.

Clause 12. The method of any of clauses 9 to 11, further comprising: receiving, from the UE, a request for the PO to be scheduled during the second window of time.

Clause 13. The method of clause 12, wherein the request indicates the second window of time via an input offset to a PO scheduling algorithm that is used to derive timing of the PO, or wherein the request indicates the second window of time via an output offset from the PO scheduling algorithm, or a combination thereof.

Clause 14. The method of any of clauses 12 to 13, wherein the request corresponds to a Msg3 physical uplink shared channel (PUSCH), or wherein the request corresponds to a MsgA PUSCH, or wherein the request corresponds to an uplink control information (UCI) multiplexed with PUSCH, or wherein the request corresponds to a Msg3 PUSCH demodulation reference signal (DMRS) resource, or wherein the request corresponds to a dedicated physical random access channel (PRACH) preamble, or any combination thereof.

Clause 15. The method of any of clauses 9 to 14, further comprising: receiving, from a location management function (LMF), a request for the PO to be scheduled during the second window of time.

Clause 16. The method of any of clauses 9 to 15, wherein the second window of time for the PO is determined implicitly based on knowledge of the PRS instance and an initial window of time associated with the PO.

Clause 17. A user equipment (UE), comprising: a memory: at least one transceiver; and at least one processor communicatively coupled to the memory and the at least one transceiver, the at least one processor configured to: determine a first window of time associated with a periodic positioning reference signal (PRS) instance; determine a second window of time associated with a paging occasion (PO) of the UE based in part upon the first window of time associated with the PRS instance; transition from a discontinuous reception (DRX) OFF state to a DRX ON state; monitor, while in the DRX ON state, the PO during the second window of time; perform, while in the DRX ON state, one or more measurements of one or more PRS resources associated with the PRS instance during the first window of time; and transition from the DRX ON state to the DRX OFF state after the first window of time and the second window of time.

Clause 18. The UE of clause 17, wherein the first window of time follows the second window of time.

Clause 19. The UE of any of clauses 17 to 18, wherein a gap between a time gap between the first window of time and the second window of time is less than a threshold, or wherein the first window of time and the second window of time are adjacent without an intervening time gap.

Clause 20. The UE of any of clauses 17 to 19, wherein the at least one processor is further configured to: transmit, via the at least one transceiver, to a base station, a request for the PO to be scheduled during the second window of time.

Clause 21. The UE of clause 20, wherein the request indicates the second window of time via an input offset to a PO scheduling algorithm that is used to derive timing of the PO, or wherein the request indicates the second window of time via an output offset from the PO scheduling algorithm, or a combination thereof.

Clause 22. The UE of any of clauses 20 to 21, wherein the request corresponds to a Msg3 physical uplink shared channel (PUSCH), or wherein the request corresponds to a MsgA PUSCH, or wherein the request corresponds to an uplink control information (UCI) multiplexed with PUSCH, or wherein the request corresponds to a Msg3 PUSCH demodulation reference signal (DMRS) resource, or wherein the request corresponds to a dedicated physical random access channel (PRACH) preamble, or any combination thereof.

Clause 23. The UE of any of clauses 17 to 22, wherein the second window of time for the PO is determined implicitly based on knowledge of the PRS instance and an initial window of time associated with the PO.

Clause 24. The UE of any of clauses 17 to 23, wherein the second window of time is configured by a network component.

Clause 25. A base station, comprising: a memory; at least one transceiver; and at least one processor communicatively coupled to the memory and the at least one transceiver, the at least one processor configured to: determine a first window of time associated with a periodic positioning reference signal (PRS) instance for a user equipment (UE); determine a second window of time associated with a paging occasion (PO) of the UE based in part upon the first window of time associated with the PRS instance; transmit, via the at least one transceiver, paging information associated with the PO during the second window of time; and transmit, via the at least one transceiver, PRS on one or more PRS resources associated with the PRS instance during the first window of time.

Clause 26. The base station of clause 25, wherein the first window of time follows the second window of time.

Clause 27. The base station of any of clauses 25 to 26, wherein a gap between a time gap between the first window of time and the second window of time is less than a threshold, or wherein the first window of time and the second window of time are adjacent without an intervening time gap.

Clause 28. The base station of any of clauses 25 to 27, wherein the at least one processor is further configured to: receive, via the at least one transceiver, from the UE, a request for the PO to be scheduled during the second window of time.

Clause 29. The base station of clause 28, wherein the request indicates the second window of time via an input offset to a PO scheduling algorithm that is used to derive timing of the PO, or wherein the request indicates the second window of time via an output offset from the PO scheduling algorithm, or a combination thereof.

Clause 30. The base station of any of clauses 28 to 29, wherein the request corresponds to a Msg3 physical uplink shared channel (PUSCH), or wherein the request corresponds to a MsgA PUSCH, or wherein the request corresponds to an uplink control information (UCI) multiplexed with PUSCH, or wherein the request corresponds to a Msg3 PUSCH demodulation reference signal (DMRS) resource, or wherein the request corresponds to a dedicated physical random access channel (PRACH) preamble, or any combination thereof.

Clause 31. The base station of any of clauses 25 to 30, wherein the at least one processor is further configured to: receive, via the at least one transceiver, from a location management function (LMF), a request for the PO to be scheduled during the second window of time.

Clause 32. The base station of any of clauses 25 to 31, wherein the second window of time for the PO is determined implicitly based on knowledge of the PRS instance and an initial window of time associated with the PO.

Clause 33. A user equipment (UE), comprising: means for determining a first window of time associated with a periodic positioning reference signal (PRS) instance; means for determining a second window of time associated with a paging occasion (PO) of the UE based in part upon the first window of time associated with the PRS instance; means for transitioning from a discontinuous reception (DRX) OFF state to a DRX ON state; means for monitoring, while in the DRX ON state, the PO during the second window of time; means for performing, while in the DRX ON state, one or more measurements of one or more PRS resources associated with the PRS instance during the first window of time; and means for transitioning from the DRX ON state to the DRX OFF state after the first window of time and the second window of time.

Clause 34. The UE of clause 33, wherein the first window of time follows the second window of time.

Clause 35. The UE of any of clauses 33 to 34, wherein a gap between a time gap between the first window of time and the second window of time is less than a threshold, or wherein the first window of time and the second window of time are adjacent without an intervening time gap.

Clause 36. The UE of any of clauses 33 to 35, further comprising: means for transmitting, to a base station, a request for the PO to be scheduled during the second window of time.

Clause 37. The UE of clause 36, wherein the request indicates the second window of time via an input offset to a PO scheduling algorithm that is used to derive timing of the PO, or wherein the request indicates the second window of time via an output offset from the PO scheduling algorithm, or a combination thereof.

Clause 38. The UE of any of clauses 36 to 37, wherein the request corresponds to a Msg3 physical uplink shared channel (PUSCH), or wherein the request corresponds to a MsgA PUSCH, or wherein the request corresponds to an uplink control information (UCI) multiplexed with PUSCH, or wherein the request corresponds to a Msg3 PUSCH demodulation reference signal (DMRS) resource, or wherein the request corresponds to a dedicated physical random access channel (PRACH) preamble, or any combination thereof.

Clause 39. The UE of any of clauses 33 to 38, wherein the second window of time for the PO is determined implicitly based on knowledge of the PRS instance and an initial window of time associated with the PO.

Clause 40. The UE of any of clauses 33 to 39, wherein the second window of time is configured by a network component.

Clause 41. A base station, comprising: means for determining a first window of time associated with a periodic positioning reference signal (PRS) instance for a user equipment (UE); means for determining a second window of time associated with a paging occasion (PO) of the UE based in part upon the first window of time associated with the PRS instance: means for transmitting paging information associated with the PO during the second window of time; and means for transmitting PRS on one or more PRS resources associated with the PRS instance during the first window of time.

Clause 42. The base station of clause 41, wherein the first window of time follows the second window of time.

Clause 43. The base station of any of clauses 41 to 42, wherein a gap between a time gap between the first window of time and the second window of time is less than a threshold, or wherein the first window of time and the second window of time are adjacent without an intervening time gap.

Clause 44. The base station of any of clauses 41 to 43, further comprising: means for receiving, from the UE, a request for the PO to be scheduled during the second window of time.

Clause 45. The base station of clause 44, wherein the request indicates the second window of time via an input offset to a PO scheduling algorithm that is used to derive timing of the PO, or wherein the request indicates the second window of time via an output offset from the PO scheduling algorithm, or a combination thereof.

Clause 46. The base station of any of clauses 44 to 45, wherein the request corresponds to a Msg3 physical uplink shared channel (PUSCH), or wherein the request corresponds to a MsgA PUSCH, or wherein the request corresponds to an uplink control information (UCI) multiplexed with PUSCH, or wherein the request corresponds to a Msg3 PUSCH demodulation reference signal (DMRS) resource, or wherein the request corresponds to a dedicated physical random access channel (PRACH) preamble, or any combination thereof.

Clause 47. The base station of any of clauses 41 to 46, further comprising: means for receiving, from a location management function (LMF), a request for the PO to be scheduled during the second window of time.

Clause 48. The base station of any of clauses 41 to 47, wherein the second window of time for the PO is determined implicitly based on knowledge of the PRS instance and an initial window of time associated with the PO.

Clause 49. A non-transitory computer-readable medium storing computer-executable instructions that, when executed by a user equipment (UE), cause the UE to: determine a first window of time associated with a periodic positioning reference signal (PRS) instance; determine a second window of time associated with a paging occasion (PO) of the UE based in part upon the first window of time associated with the PRS instance; transition from a discontinuous reception (DRX) OFF state to a DRX ON state; monitor, while in the DRX ON state, the PO during the second window of time: perform, while in the DRX ON state, one or more measurements of one or more PRS resources associated with the PRS instance during the first window of time; and transition from the DRX ON state to the DRX OFF state after the first window of time and the second window of time.

Clause 50. The non-transitory computer-readable medium of clause 49, wherein the first window of time follows the second window of time.

Clause 51. The non-transitory computer-readable medium of any of clauses 49 to 50, wherein a gap between a time gap between the first window of time and the second window of time is less than a threshold, or wherein the first window of time and the second window of time are adjacent without an intervening time gap.

Clause 52. The non-transitory computer-readable medium of any of clauses 49 to 51, further comprising computer-executable instructions that, when executed by the UE, cause the UE to: transmit, to a base station, a request for the PO to be scheduled during the second window of time.

Clause 53. The non-transitory computer-readable medium of clause 52, wherein the request indicates the second window of time via an input offset to a PO scheduling algorithm that is used to derive timing of the PO, or wherein the request indicates the second window of time via an output offset from the PO scheduling algorithm, or a combination thereof.

Clause 54. The non-transitory computer-readable medium of any of clauses 52 to 53, wherein the request corresponds to a Msg3 physical uplink shared channel (PUSCH), or wherein the request corresponds to a MsgA PUSCH, or wherein the request corresponds to an uplink control information (UCI) multiplexed with PUSCH, or wherein the request corresponds to a Msg3 PUSCH demodulation reference signal (DMRS) resource, or wherein the request corresponds to a dedicated physical random access channel (PRACH) preamble, or any combination thereof.

Clause 55. The non-transitory computer-readable medium of any of clauses 49 to 54, wherein the second window of time for the PO is determined implicitly based on knowledge of the PRS instance and an initial window of time associated with the PO.

Clause 56. The non-transitory computer-readable medium of any of clauses 49 to 55, wherein the second window of time is configured by a network component.

Clause 57. A non-transitory computer-readable medium storing computer-executable instructions that, when executed by a base station, cause the base station to: determine a first window of time associated with a periodic positioning reference signal (PRS) instance for a user equipment (UE); determine a second window of time associated with a paging occasion (PO) of the UE based in part upon the first window of time associated with the PRS instance: transmit paging information associated with the PO during the second window of time; and transmit PRS on one or more PRS resources associated with the PRS instance during the first window of time.

Clause 58. The non-transitory computer-readable medium of clause 57, wherein the first window of time follows the second window of time.

Clause 59. The non-transitory computer-readable medium of any of clauses 57 to 58, wherein a gap between a time gap between the first window of time and the second window of time is less than a threshold, or wherein the first window of time and the second window of time are adjacent without an intervening time gap.

Clause 60. The non-transitory computer-readable medium of any of clauses 57 to 59, further comprising computer-executable instructions that, when executed by the base station, cause the base station to: receive, from the UE, a request for the PO to be scheduled during the second window of time.

Clause 61. The non-transitory computer-readable medium of clause 60, wherein the request indicates the second window of time via an input offset to a PO scheduling algorithm that is used to derive timing of the PO, or wherein the request indicates the second window of time via an output offset from the PO scheduling algorithm, or a combination thereof.

Clause 62. The non-transitory computer-readable medium of any of clauses 60 to 61, wherein the request corresponds to a Msg3 physical uplink shared channel (PUSCH), or wherein the request corresponds to a MsgA PUSCH, or wherein the request corresponds to an uplink control information (UCI) multiplexed with PUSCH, or wherein the request corresponds to a Msg3 PUSCH demodulation reference signal (DMRS) resource, or wherein the request corresponds to a dedicated physical random access channel (PRACH) preamble, or any combination thereof.

Clause 63. The non-transitory computer-readable medium of any of clauses 57 to 62, further comprising computer-executable instructions that, when executed by the base station, cause the base station to: receive, from a location management function (LMF), a request for the PO to be scheduled during the second window of time.

Clause 64. The non-transitory computer-readable medium of any of clauses 57 to 63, wherein the second window of time for the PO is determined implicitly based on knowledge of the PRS instance and an initial window of time associated with the PO.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

What is claimed is:

1. A method of operating a user equipment (UE), comprising:
determining a first window of time associated with a periodic positioning reference signal (PRS) instance;
determining a second window of time associated with a paging occasion (PO) of the UE based in part upon the first window of time associated with the PRS instance;
transitioning from a discontinuous reception (DRX) OFF state to a DRX ON state;
monitoring, while in the DRX ON state, the PO during the second window of time;
performing, while in the DRX ON state, one or more measurements of one or more PRS resources associated with the PRS instance during the first window of time; and
transitioning from the DRX ON state to the DRX OFF state after the first window of time and the second window of time.

2. The method of claim 1, wherein the first window of time follows the second window of time.

3. The method of claim 1,
wherein a gap between a time gap between the first window of time and the second window of time is less than a threshold, or
wherein the first window of time and the second window of time are adjacent without an intervening time gap.

4. The method of claim 1, further comprising:
transmitting, to a base station, a request for the PO to be scheduled during the second window of time.

5. The method of claim 4,
wherein the request indicates the second window of time via an input offset to a PO scheduling algorithm that is used to derive timing of the PO, or
wherein the request indicates the second window of time via an output offset from the PO scheduling algorithm, or
a combination thereof.

6. The method of claim 4,
wherein the request corresponds to a Msg3 physical uplink shared channel (PUSCH), or
wherein the request corresponds to a MsgA PUSCH, or
wherein the request corresponds to an uplink control information (UCI) multiplexed with PUSCH, or
wherein the request corresponds to a Msg3 PUSCH demodulation reference signal (DMRS) resource, or
wherein the request corresponds to a dedicated physical random access channel (PRACH) preamble, or
any combination thereof.

7. The method of claim 1, wherein the second window of time for the PO is determined implicitly based on knowledge of the PRS instance and an initial window of time associated with the PO.

8. The method of claim 1, wherein the second window of time is configured by a network component.

9. A method of operating a base station, comprising:
determining a first window of time associated with a periodic positioning reference signal (PRS) instance for a user equipment (UE);
determining a second window of time associated with a paging occasion (PO) of the UE based in part upon the first window of time associated with the PRS instance;
transmitting paging information associated with the PO during the second window of time; and
transmitting PRS on one or more PRS resources associated with the PRS instance during the first window of time.

10. The method of claim 9, wherein the first window of time follows the second window of time.

11. The method of claim 9,
wherein a gap between a time gap between the first window of time and the second window of time is less than a threshold, or
wherein the first window of time and the second window of time are adjacent without an intervening time gap.

12. The method of claim 9, further comprising:
receiving, from the UE, a request for the PO to be scheduled during the second window of time.

13. The method of claim 12,
wherein the request indicates the second window of time via an input offset to a PO scheduling algorithm that is used to derive timing of the PO, or
wherein the request indicates the second window of time via an output offset from the PO scheduling algorithm, or
a combination thereof.

14. The method of claim 12,
wherein the request corresponds to a Msg3 physical uplink shared channel (PUSCH), or
wherein the request corresponds to a MsgA PUSCH, or
wherein the request corresponds to an uplink control information (UCI) multiplexed with PUSCH, or
wherein the request corresponds to a Msg3 PU SCH demodulation reference signal (DMRS) resource, or
wherein the request corresponds to a dedicated physical random access channel (PRACH) preamble, or
any combination thereof.

15. The method of claim 9, further comprising:
receiving, from a location management function (LMF), a request for the PO to be scheduled during the second window of time.

16. The method of claim 9, wherein the second window of time for the PO is determined implicitly based on knowledge of the PRS instance and an initial window of time associated with the PO.

17. A user equipment (UE), comprising:
a memory;
at least one transceiver; and
at least one processor communicatively coupled to the memory and the at least one transceiver, the at least one processor configured to:
determine a first window of time associated with a periodic positioning reference signal (PRS) instance;
determine a second window of time associated with a paging occasion (PO) of the UE based in part upon the first window of time associated with the PRS instance;
transition from a discontinuous reception (DRX) OFF state to a DRX ON state;
monitor, while in the DRX ON state, the PO during the second window of time;
perform, while in the DRX ON state, one or more measurements of one or more PRS resources associated with the PRS instance during the first window of time; and
transition from the DRX ON state to the DRX OFF state after the first window of time and the second window of time.

18. The UE of claim 17, wherein the first window of time follows the second window of time.

19. The UE of claim 17,
wherein a gap between a time gap between the first window of time and the second window of time is less than a threshold, or
wherein the first window of time and the second window of time are adjacent without an intervening time gap.

20. The LE of claim 17, wherein the at least one processor is further configured to:
transmit, via the at least one transceiver, to a base station, a request for the PO to be scheduled during the second window of time.

21. The UE of claim 20,
wherein the request indicates the second window of time via an input offset to a PO scheduling algorithm that is used to derive timing of the PO, or
wherein the request indicates the second window of time via an output offset from the PO scheduling algorithm, or
a combination thereof.

22. The UE of claim 20,
wherein the request corresponds to a Msg3 physical uplink shared channel (PU SCH), or
wherein the request corresponds to a MsgA PUSCH, or
wherein the request corresponds to an uplink control information (UCI) multiplexed with PUSCH, or
wherein the request corresponds to a Msg3 PUSCH demodulation reference signal (DMRS) resource, or
wherein the request corresponds to a dedicated physical random access channel (PRACH) preamble, or
any combination thereof.

23. The UE of claim 17, wherein the second window of time for the PO is determined implicitly based on knowledge of the PRS instance and an initial window of time associated with the PO.

24. The UE of claim 17, wherein the second window of time is configured by a network component.

25. A base station, comprising:
a memory;
at least one transceiver; and
at least one processor communicatively coupled to the memory and the at least one transceiver, the at least one processor configured to:
determine a first window of time associated with a periodic positioning reference signal (PRS) instance for a user equipment (UE);
determine a second window of time associated with a paging occasion (PO) of the UE based in part upon the first window of time associated with the PRS instance;
transmit, via the at least one transceiver, paging information associated with the PO during the second window of time; and
transmit, via the at least one transceiver, PRS on one or more PRS resources associated with the PRS instance during the first window of time.

26. The base station of claim 25, wherein the first window of time follows the second window of time.

27. The base station of claim 25,
wherein a gap between a time gap between the first window of time and the second window of time is less than a threshold, or
wherein the first window of time and the second window of time are adjacent without an intervening time gap.

28. The base station of claim 25, wherein the at least one processor is further configured to:
receive, via the at least one transceiver, from the UE, a request for the PO to be scheduled during the second window of time.

29. The base station of claim 28,
wherein the request indicates the second window of time via an input offset to a PO scheduling algorithm that is used to derive timing of the PO, or
wherein the request indicates the second window of time via an output offset from the PO scheduling algorithm, or
a combination thereof.

30. The base station of claim 28,
wherein the request corresponds to a Msg3 physical uplink shared channel (PUSCH), or
wherein the request corresponds to a MsgA PUSCH, or
wherein the request corresponds to an uplink control information (UCI) multiplexed with PUSCH, or
wherein the request corresponds to a Msg3 PUSCH demodulation reference signal (DMRS) resource, or
wherein the request corresponds to a dedicated physical random access channel (PRACH) preamble, or
any combination thereof.
